(19) United States
(12) Patent Application Publication
(10) Pub. No.: US 2011/0001937 A1
(43) Pub. Date: Jan. 6, 2011

(54) Projection Display Device And Illumination Device

(75) Inventor: Shinya MATSUMOTO, Uji-City (JP)

Correspondence Address: NDQ&M WATCHSTONE LLP, 300 NEW JERSEY AVENUE, NW, FIFTH FLOOR, WASHINGTON, DC, 20001, US

(73) Assignee: Sanyo Electric Co., Ltd., Osaka (JP)

(21) Appl. No.: 12/876,851

(22) Filed: Sep. 7, 2010

Related U.S. Application Data
(63) Continuation of application No. PCT/JP2009/053488, filed on Feb. 26, 2009.

(30) Foreign Application Priority Data
Mar. 7, 2008 (JP) 2008-058384
Feb. 4, 2009 (JP) 2009-024213

(51) Int. Cl. G03B 21/16; F21S 4/00

(52) U.S. Cl. 353/54; 353/52; 362/249.01

(57) ABSTRACT

A projection display device includes an optical system which modulates light based on an image signal to generate and output image light; an illumination device which has a plurality of light sources, and emits illumination light in a predetermined axis direction in parallel to an installation plane of the optical system to supply the illumination light to the optical system; a heat transfer system which transfers a heat generated in the light sources in a direction generally perpendicular to the installation plane; and a cooling device which is disposed in a direction generally perpendicular to the installation plane, and removes the heat transferred by the heat transfer system.

This application is a continuation of International App. No. PCT/JP2009/53488, filed Feb. 26, 2009, and designating the U.S., which International Application claims priority to Japanese Pat. App. No. 2009-024213, filed Feb. 4, 2009, and Japanese Pat. App. No. 2008-058384, filed Mar. 7, 2008. The disclosures of the above applications are incorporated herein by reference in their entireties.

### BACKGROUND OF THE INVENTION

1. Field of the Invention

The present invention relates to a projection display device and an illumination device, and more particularly to an arrangement for use in generating illumination light by using a laser light source.

2. Disclosure of Related Art

Conventionally, a projection display device (hereinafter, called as a “projector”) for enlarging and projecting light modulated by an image signal onto a screen has been commercialized and widely used. The projector of this kind is loaded with an illumination device for supplying illumination light to an imager such as a liquid crystal panel. Heretofore, there has been used a lamp light source such as an ultra high pressure mercury lamp, a metal halide lamp, or a xenon lamp.

On the other hand, in recent years, there has been developed a projector incorporated with a solid-state light source such as a semiconductor laser, in place of a lamp light source. A laser light source is advantageous in expressing a wide color space with high luminance and high precision, and is expected as a light source for a next-generation projector. In the case where an image is projected onto a large screen by using the projector of this kind, it is necessary to further increase the luminance of illumination light.

As a method for increasing the luminance of illumination light, there is proposed an arrangement, wherein plural laser light sources are arranged in a two-dimensional array, or an arrangement, wherein laser light emitted from plural laser light sources is combined by using a prism mirror. Further, in the arrangement incorporated with the prism mirror, it is possible to reduce the cross-sectional area (light beam area) of illumination light by properly adjusting the dispositions of the laser light sources and the prism mirror, and enhance the light use efficiency based on Etendue theory.

A laser light source has a characteristic that the emission intensity thereof is varied depending on a temperature change. In view of the above, in an illumination device incorporated with a laser light source as described above, it is necessary to provide a system of properly controlling an emission intensity of the laser light source by removing a heat generated in the laser light source.

In the above arrangement, it is advantageous to use a method, in which a heat is transferred from a laser light source by a cooling element such as a Peltier element or a heat pipe, and the transferred heat is removed by a radiator or a heat sink, rather than using a method, in which cooling air is blown onto a laser light source, in order to smoothly adjust the temperature of the laser light source. In the above method, however, a large-scaled cooling system is required, which may resultantly increase the size of a projector main body. Further, in the above cooling system, there is used a pipe for circulating a coolant, or a heat pipe for directly transferring a heat, as a heat transfer system for transferring the heat generated in the laser light source to the radiator or the heat sink, in view of the above, in the cooling system, it is necessary to properly dispose the laser light source and the heat transfer system in order to further enhance the light use efficiency based on Etendue theory, while preventing blocking of laser light by the heat transfer system.

### SUMMARY OF THE INVENTION

A projection display device according to a first aspect of the invention includes an optical system which modulates light based on an image signal to generate and output image light; an illumination device which has a plurality of light sources, and emits illumination light in a predetermined axis direction in parallel to an installation plane of the optical system to supply the illumination light to the optical system; a heat transfer system which transfers a heat generated in the light sources in a direction generally perpendicular to the installation plane; and a cooling device which is disposed in a direction generally perpendicular to the installation plane, and removes the heat transferred by the heat transfer system.

In the projection display device according to the first aspect of the invention, since the cooling device is disposed in an upper position or a lower position with respect to the optical system, it is possible to reduce the outer size of the projection display device, as compared with an arrangement, wherein a cooling device is disposed in parallel to an installation plane of an optical system. Further, it is possible to suppress elongation of the heat transfer system by disposing the cooling device at a position immediately above or immediately below the illumination device.

A second aspect of the invention is directed to an illumination device provided with a plurality of light sources, and adapted to emit light from the plurality of the light sources in a first axis direction. The illumination device according to the second aspect includes a heat transfer system which transfers a heat generated in the light sources in a second axis direction perpendicular to the first axis direction, and a cooling device which is provided in a direction perpendicular to the first axis direction, and removes the heat transferred by the heat transfer system.

A third aspect of the invention is directed to an illumination device provided with a plurality of light sources, and adapted to emit light from the plurality of the light sources in a first axis direction. The illumination device according to the third aspect includes a first light source which emits light in a second axis direction perpendicular to the first axis direction; a first heat transfer system which transfers a heat generated in the first light source in a third axis direction perpendicular to the first axis direction and the second axis direction; a second light source which emits light in the second axis direction, and is disposed at a forward position or a rearward position in a light emission direction of the first light source; a second heat transfer system which transfers a heat generated in the second light source in the third axis direction; a cooling device which is disposed in the third axis direction, and removes the heats transferred by the first heat transfer system and the second heat transfer system; and reflection means which guides the light emitted from the first light source and the light emitted from the second light source in the first axis direction. In this arrangement, the first light source and the second light source are disposed at such positions that the rearward light source is displaced with respect to the forward light source in a direction opposite to the heat transfer direction.

In the illumination devices according to the second aspect and the third aspect of the invention, since the cooling device is disposed in an upper position or a lower position with respect to the light source group, it is possible to reduce the overall outer size of the illumination device including the cooling device, as compared with an arrangement, wherein a cooling device is disposed transversely with respect to a light source group. Further, it is possible to suppress elongation of the heat transfer system by disposing the cooling device at a position immediately above or immediately below the light source group.

Further, in the illumination device according to the third aspect, since the rearward light source out of the first and the second light sources is disposed with a displacement with respect to the forward light source in the direction opposite to the heat transfer direction by a predetermined distance, there is no likelihood that the heat transfer system for the forward light source may be positioned on an optical path of light emitted from the rearward light source. Accordingly, there is no likelihood that the light emitted from the rearward light source may be blocked by the heat transfer system for the forward light source.

A projection display device according to a fourth aspect of the invention includes an optical system which modulates light based on an image signal to generate and output image light; a light source which supplies the light to the optical system; a heat transfer system which transfers a heat generated in the light source; and a cooling device which removes the heat transferred by the heat transfer system. In this arrangement, the heat transfer system includes a cooling portion which is mounted with the light source, and which is internally formed with a flow channel through which a refrigerant from the cooling device is circulated. Further, the cooling portion is disposed, with a surface thereof where the light source is mounted being aligned with a gravitational force direction.

In the projection display device according to the fourth aspect of the invention, since the air (air bubbles) in the flow channel is less likely to stagnate near the light source mounting surface, it is possible to suppress lowering of heat transfer (increase of thermal resistance) resulting from stagnation of the air (air bubbles).

### BRIEF DESCRIPTION OF THE DRAWINGS

These and other objects, and novel features of the present invention will become more apparent upon reading the following detailed description of the embodiment along with the accompanying drawings.

FIGS. 1A and 1B are diagrams showing an arrangement of a projector in a first embodiment of the invention.

FIGS. 2A, 2B, 2C, and 2D are diagrams showing an arrangement of the light source unit in the first embodiment.

FIGS. 3A, 3B, 3C, and 3D are diagrams showing an arrangement of the light source unit in the first embodiment.

FIGS. 4A, 4B, 4C, 4D, 4E, and 4F are diagrams explaining disposition methods of light source units in the first embodiment.

FIG. 5 is a diagram (perspective view) showing how laser light is combined in the first embodiment.

FIGS. 6A and 6B are diagrams (top plan view/front view) showing how laser light is combined in the first embodiment.

FIG. 7 is a diagram (perspective view) showing how laser light is combined in the first embodiment.

FIGS. 8A and 8B are diagrams (top plan view/front view) showing how laser light is combined in the first embodiment.

FIG. 9 is a diagram (perspective view) showing how laser light is combined in the first embodiment.

FIGS. 10A and 10B are diagrams (top plan view/front view) showing how laser light is combined in the first embodiment.

FIG. 11 is a diagram (perspective view) showing how laser light is combined in the first embodiment.

FIGS. 12A and 12B are diagrams (top plan view/front view) showing how laser light is combined in the first embodiment.

FIG. 13 is a diagram (perspective view) showing how laser light is combined in the first embodiment.

FIGS. 14A and 14B are diagrams (top plan view/front view) showing how laser light is combined in the first embodiment.

FIG. 15 is a diagram (perspective view) showing how laser light is combined in the first embodiment.

FIGS. 16A and 16B are diagrams (top plan view/front view) showing how laser light is combined in the first embodiment.

FIGS. 17A and 17B are diagrams (top plan view/front view) showing how laser light is combined in the first embodiment.

FIG. 18 is a diagram (perspective view) showing how laser light is combined in the first embodiment.

FIGS. 19A and 19B are diagrams (top plan view/front view) showing how laser light is combined in the first embodiment.

FIG. 20 is a diagram (perspective view) showing how laser light is combined in the first embodiment.

FIGS. 21A and 21B are diagrams (top plan view/front view) showing how laser light is combined in the first embodiment.

FIG. 22 is a diagram (perspective view) showing how laser light is combined in the first embodiment.

FIGS. 23A and 23B are diagrams (top plan view/front view) showing how laser light is combined in the first embodiment.

FIGS. 24A and 24B are diagrams showing an arrangement of a projector in a second embodiment.

FIGS. 25A and 25B are diagrams (top plan view/front view) showing how laser light is combined in the second embodiment.

FIGS. 26A and 26B are diagrams (top plan view/front view) showing how laser light is combined in the second embodiment.

FIGS. 27A and 27B are diagrams (top plan view/front view) showing how laser light is combined in the second embodiment.

FIGS. 28A and 28B are diagrams (top plan view/front view) showing how laser light is combined in the second embodiment.

FIGS. 29A and 29B are diagrams (top plan view/front view) showing how laser light is combined in the second embodiment.

FIGS. 30A and 30B are diagrams (top plan view/front view) showing how laser light is combined in the second embodiment.

FIGS. 31A and 31B are diagrams (top plan view/front view) showing how laser light is combined in the second embodiment.

FIGS. 32A and 32B are diagrams (top plan view/front view) showing how laser light is combined in the second embodiment.

FIGS. 33A and 33B are diagrams (top plan view/front view) showing how laser light is combined in the second embodiment.

FIGS. 34A and 34B are diagrams (top plan view/front view) showing how laser light is combined in the second embodiment.

FIGS. 35A and 35B are diagrams showing another arrangement example of a light source unit.

FIGS. 36A, 36B, 36C, and 36D are diagrams showing an arrangement of a liquid cooling jacket as another arrangement example.

FIGS. 37A and 37B are diagrams for describing a cooling operation of a laser light source to be performed by a cooling portion as another arrangement example.

FIGS. 38A an 38B are diagrams showing modification examples of the liquid cooling jacket as another arrangement example.

The drawings are provided mainly for describing the present invention, and do not limit the scope of the present invention.

### DESCRIPTION OF PREFERRED EMBODIMENTS

In the following, embodiments of the invention are described referring to the drawings.

### A. First Embodiment

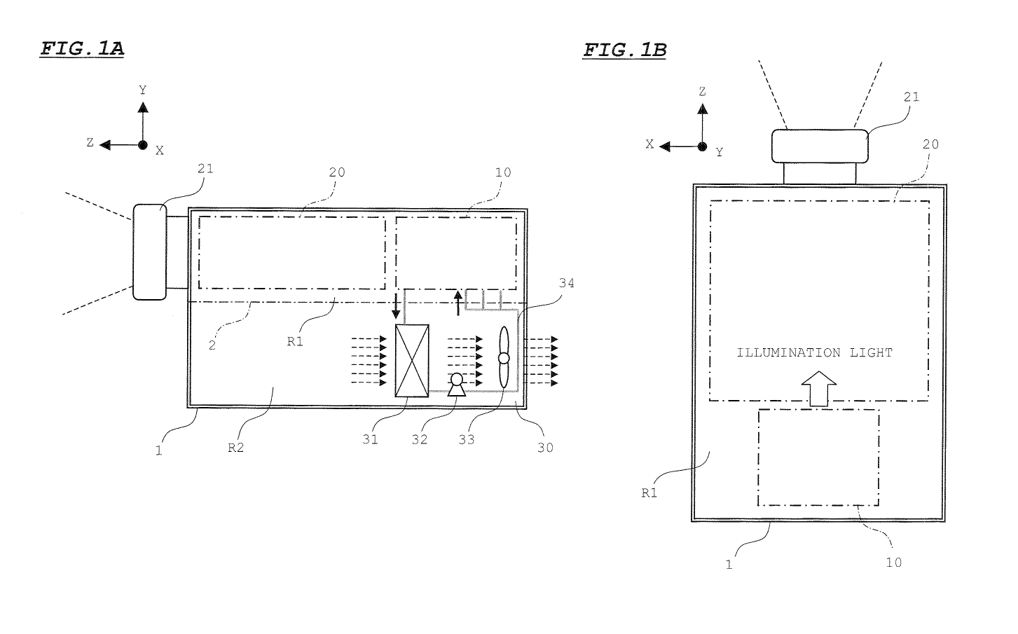

FIGS. 1A and 1B show an arrangement of a projector embodying the invention. FIG. 1A is a perspective side view of the projector, and FIG. 1B is a perspective top plan view of the projector.

Referring to FIGS. 1A and 1B, the interior of a projector 1 is divided into a space R1 in the upper position and a space R2 in the lower position by a partition plate 2. An optical system 20 for modulating light in accordance with an image signal, and an illumination device 10 for supplying illumination light to the optical system 20 are disposed in the space R1. The optical system 20 may be constituted of a well-known optical system such as an LCOS optical system or a DLP optical system, in place of an optical system incorporated with a liquid crystal panel as an imager. Light (image light) modulated by the optical system 20 is projected onto a projection plane (screen) through a projection lens 21. The members constituting the optical system 20 are disposed on an installation plane in parallel to X-Z plane shown in FIGS. 1A and 1B.

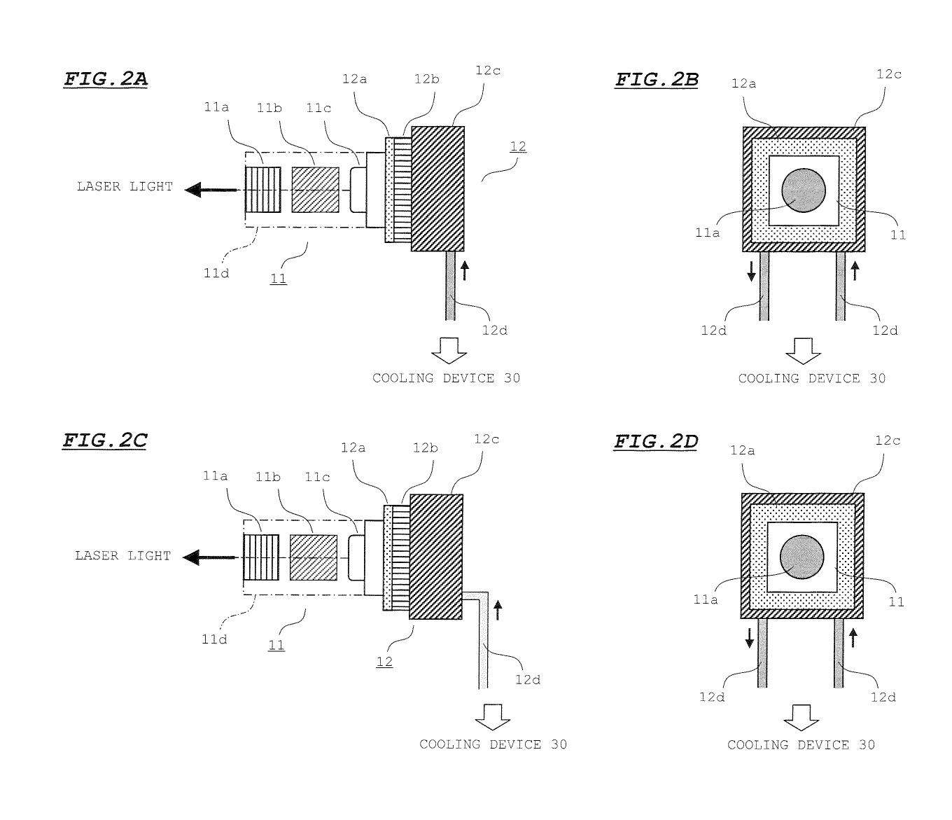

A cooling device 30 is disposed immediately below the illumination device 10 in the space R2. The cooling device 30 is provided with a radiator 31, a pump 32, a fan 33, and a plumbing pipe 34. The plumbing pipe 34 is adapted to connect the radiator 31 and the pump 32, and extends from an opening formed in the partition plate 2 into the space R1 to be connected to plumbing pipes 12d (see FIGS. 2A, 2B, 2C, and 2D) of a cooling portion 12 mounted on a laser light source 11 in the illumination device 10. The radiator 31, the pump 32, and the cooling portion of the laser light source are connected to each other in the form of a closed loop by the plumbing pipes 34 and 12d, whereby a flow channel of a refrigerant is formed.

When the pump 32 is driven, a refrigerant is circulated through the plumbing pipes 12d, and a heat generated in the laser light source is transferred to the radiator 31. The heat transferred to the radiator 31 is removed by the air supplied to the radiator 31 by the fan 33. In this way, the heat generated in the laser light source is released to the exterior, and the temperature of the laser light source is adjusted to a predetermined temperature.

FIGS. 2A and 2B are diagrams showing an arrangement example of the light source unit. FIGS. 2C and 2D are diagrams showing another arrangement example of the light source unit. FIGS. 2A and 2C are side view of the laser light source, and FIGS. 2B and 2D are front view of the laser light source.

Referring to FIGS. 2A and 2B, a light source unit is constituted of the laser light source 11 and the cooling portion 12. The laser light source 11 is constituted of a reflection element 11a having a wavelength selectivity, a wavelength conversion element 11b, a laser diode 11c, and a housing 11d for housing the reflection element 11a, the wavelength conversion element 11b, and the laser diode 11c. The laser diode 11c emits laser light of wavelength λ1. The wavelength conversion element 11b generates laser light of wavelengthλ2 (λ2<λ1) from the laser light of wavelength λ1. The reflection element 11a transmits the laser light of wavelength λ2, and reflects the laser light of wavelength λ1. The laser light of wavelength λ1 repeats reflection between the reflection element 11a and the laser diode 11c, and generates the laser light of wavelength λ2 by the wavelength conversion element 11b during the repetitive reflection. The generated laser light of wavelength λ2 is successively transmitted through the reflection element 11a, and emitted to the exterior through an opening formed in a front surface of the housing 11d.

The cooling portion 12 is constituted of a copper plate 12a, a Peltier element 12b, and a liquid cooling jacket 12c. The copper plate 12a is mounted on a back surface of the laser diode 11c to diffuse the heat generated in the laser diode 11c. The Peltier element 12b is mounted on the copper plate 12a to transfer the heat diffused by the copperplate 12a to the liquid cooling jacket 12c. The liquid cooling jacket 12c is internally formed with a flow channel, and the plumbing pipes 12d are connected to an entrance and an exit of the flow channel. A refrigerant flows in the liquid cooling jacket 12c from one of the two plumbing pipes 12d, and flows out from the other of the two plumbing pipes 12d. In this way, the refrigerant is circulated through the flow channel within the liquid cooling jacket 12c, and the heat transferred from the Peltier element 12b to the liquid cooling jacket 12c is transferred to the refrigerant circulating in the liquid cooling jacket 12c. As described above, the heat is transferred to the radiator 31 by the refrigerant, and removed by the air passing through the radiator 31.

In the arrangement example shown in FIGS. 2A and 2B, the plumbing pipes 12d are arranged to extend downward from a lower surface of the liquid cooling jacket 12c. Alternatively, as shown in the arrangement example in FIGS. 2C and 2D, plumbing pipes 12d may be projected from a lower portion on a back surface of a liquid cooling jacket 12c by a predetermined length, and bent downward so that the plumbing pipes 12d are directed downward. The light source units shown in FIGS. 2A, 2B, 2C, and 2D are adapted to emit laser light of a green wavelength band, and laser light of a blue wavelength band.

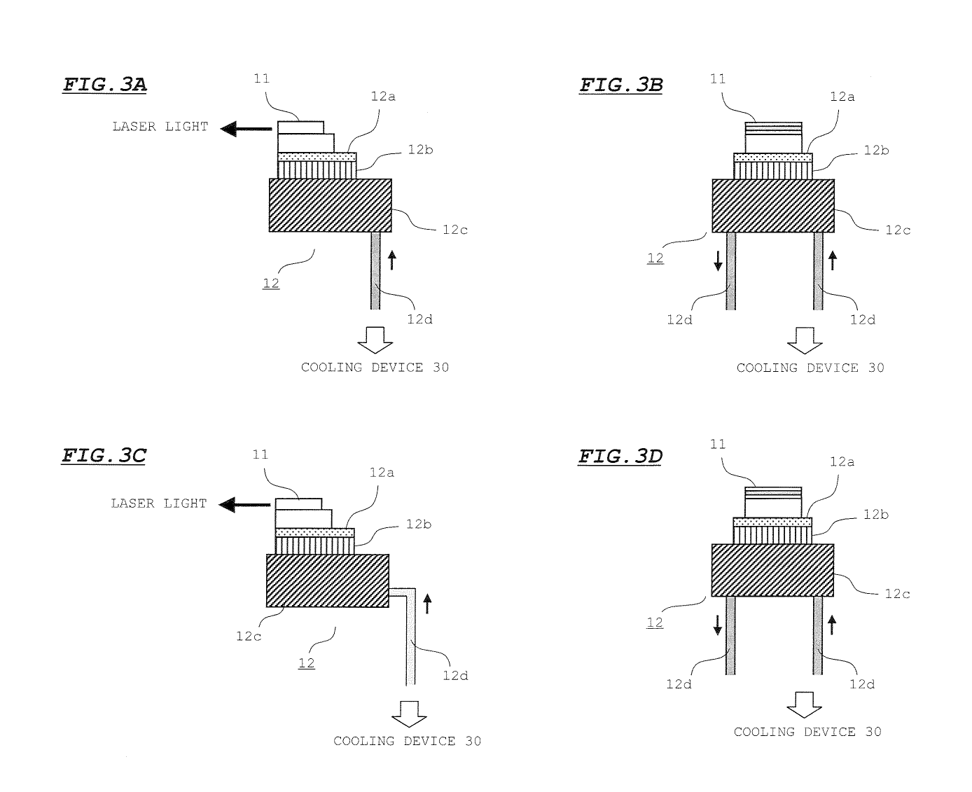

FIGS. 3A and 3B are diagrams showing another arrangement example of the light source unit. FIGS. 3C and 3D are diagrams showing modification example of the arrangement example. FIGS. 3A and 3C are side view of the laser light source, and FIGS. 3B and 3D are front view of the laser light source. The light source unit shown in FIGS. 3A, 3B, 3C and 3D is adapted to emit laser light of a red wavelength band.

In the arrangement example shown in FIGS. 3A and 3B, a laser light source 11 is constituted of a semiconductor laser array. The semiconductor laser array is constructed in such a manner that plural laser emitting portions are arranged in left and right directions in FIG. 3B. A copper plate 12a is mounted on a lower surface of the laser light source 11, and a Peltier element 12b and a liquid cooling jacket 12c are mounted in this order. The arrangements and the functions of the Peltier element 12b and the liquid cooling jacket 12c are the same as those in the arrangement examples shown in FIGS. 2A, 2B, 2C, and 2D.

In the arrangement example shown in FIGS. 3A and 3B, the plumbing pipes 12d are arranged to extend downward from a lower surface of the liquid cooling jacket 12c. Alternatively, as shown in the arrangement example in FIGS. 3C and 3D, plumbing pipes 12d may be projected from a lower portion on a back surface of a liquid cooling jacket 12c by a predetermined length, and bent downward so that the plumbing pipes 12d are directed downward.

In the arrangement examples shown in FIGS. 2A through 3D, the copper plate 12a is used for heat diffusion. Alternatively, a heat conductive sheet (graphite sheet), a heat diffusion sheet, a thermal grease, or a like member may be used. Further, there is a case that non-use of the copper plate 12a is advantageous in enhancing the cooling efficiency, depending on a heat generation area of the laser light source 11 or an area of the liquid cooling jacket 12c. In such a case, the copper plate 12a may be omitted. Further alternatively, other heat transfer element may be used, in place of the Peltier element 12b.

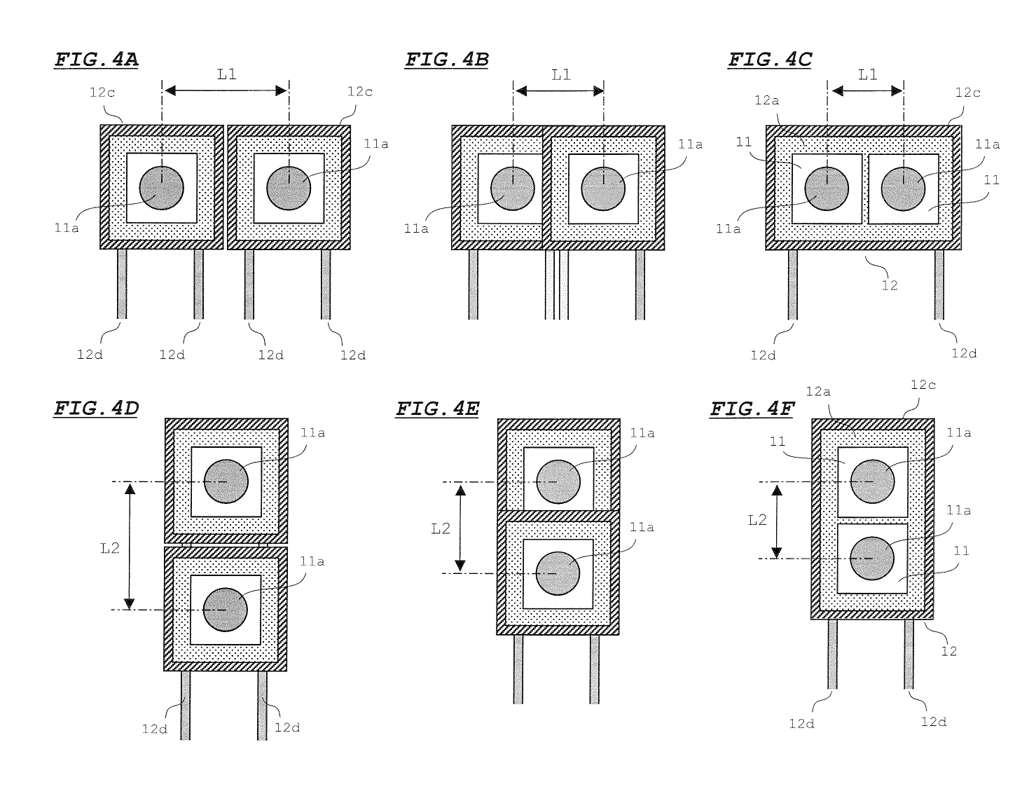

FIGS. 4A, 4B, 4C, 4D, 4E, and 4F are diagrams showing disposition methods of light source units. To simplify the description, FIGS. 4A, 4B, 4C, 4D, 4E, and 4F illustrate disposition methods, in the case where the light source units shown in FIGS. 2A, 2B, 2C, and 2D are used. However, the same disposition methods may be applied to a case where the light source units shown in FIGS. 3A, 3B, 3C, and 3D are used.

FIG. 4A shows a disposition method, wherein two light source units are arranged side by side in left and right directions. FIG. 4B shows a disposition method, wherein two light source units are disposed at forward and rearward positions in the light emission direction, while being partially overlapped with each other in left and right directions. In the disposition method shown in FIG. 4B, since the light source units are partially overlapped with each other in left and right directions, the distance L1 between the laser light sources in left and right directions is reduced, as compared with the disposition method shown in FIG. 4A. Accordingly, as compared with the disposition method shown in FIG. 4A, the disposition method shown in FIG. 4B is advantageous in reducing the overall size of a light flux obtained by combining laser light from the two light source units, and enhancing the light use efficiency based on Etendue theory.

FIG. 4C shows an arrangement example, wherein two laser light sources 11 are disposed side by side in left and right directions, and a cooling portion 12 is mounted in common between the two laser light sources 11. In this arrangement example, a copper plate 12a and a Peltier element 12b (not shown in FIG. 4C) are mounted in common between the two laser light sources 11 on the back surfaces of the two laser light sources 11, and a liquid cooling jacket 12c is also mounted in common between the two laser light sources 11. In this arrangement example, since the two laser light sources 11 can be disposed closer to each other, as compared with the arrangement example shown in FIG. 4B, the distance L1 between the laser light sources 11 in left and right directions can be further reduced, as compared with the disposition method shown in FIG. 4B. Accordingly, as compared with the disposition method shown in FIG. 4B, the disposition method shown in FIG. 4C is more advantageous in reducing the overall size of a light flux obtained by combining laser light from the two light source units, and further enhancing the light use efficiency based on Etendue theory.

FIG. 4D shows a disposition method, wherein two light source units are arranged in upward and downward directions. FIG. 4E shows a disposition method, wherein two light source units are disposed at forward and rearward positions in the light emission direction, while being partially overlapped with each other in upward and downward directions. In the disposition method shown in FIG. 4E, since the light source units are partially overlapped with each other in upward and downward directions, the distance L2 between the laser light sources in upward and downward directions is reduced, as compared with the disposition method shown in FIG. 4D. Accordingly, as compared with the disposition method shown in FIG. 4D, the disposition method shown in FIG. 4E is advantageous in reducing the overall size of a light flux obtained by combining laser light from the two light source units, and enhancing the light use efficiency based on Etendue theory.

FIG. 4F shows an arrangement example, wherein two laser light sources 11 are disposed side by side in upward and downward directions, and a cooling portion 12 is mounted in common between the two laser light sources 11. In this arrangement example, a copper plate 12a and a Peltier element 12b (not shown in FIG. 4F) are mounted in common between the two laser light sources 11 on the back surfaces of the two laser light sources 11, and a liquid cooling jacket 12c is also mounted in common between the two laser light sources 11. In this arrangement example, since the two laser light sources 11 can be disposed closer to each other, as compared with the arrangement example shown in FIG. 4E, the distance L2 between the laser light sources 11 in upward and downward directions can be further reduced, as compared with the disposition method shown in FIG. 4E. Accordingly, as compared with the disposition method shown in FIG. 4E, the disposition method shown in FIG. 4F is more advantageous in reducing the overall size of a light flux obtained by combining laser light from the two light source units, and further enhancing the light use efficiency based on Etendue theory.

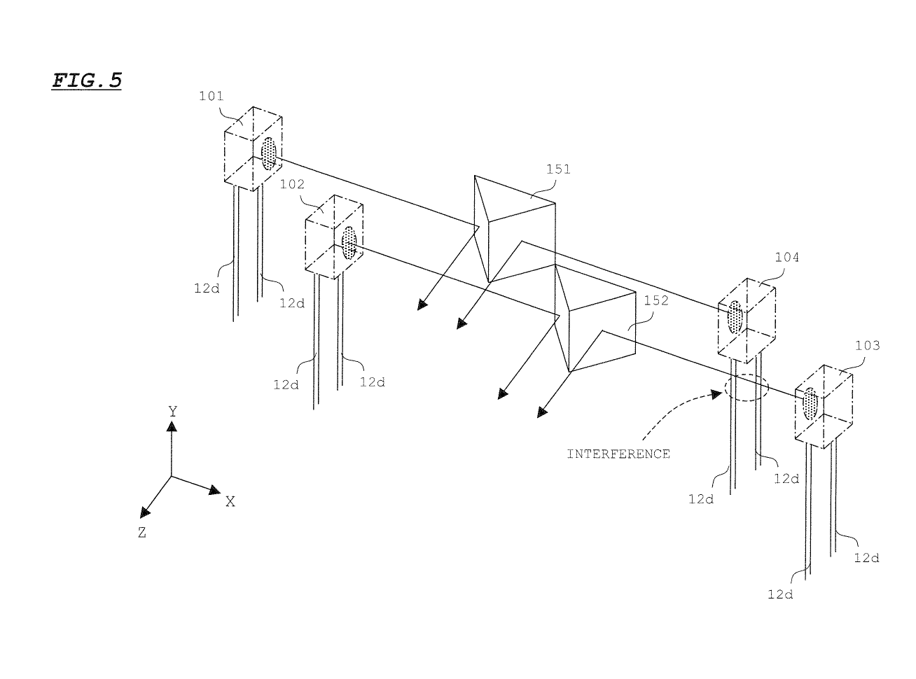

In the following, combination examples of laser light in the illumination device 10 are described. In the diagrams of FIG. 5 and thereafter, to simplify the description, the light source units shown in FIGS. 2A, 2B, 2C, and 2D are schematically illustrated. Each of the light source units may be replaced by the light source units shown in FIGS. 3A, 3B, 3C, and 3D. The illumination device 10 is required to emit laser light of at least a red wavelength band, a green wavelength band, and a blue wavelength band. Accordingly, in the following combination examples, any one of the light source units serves as a light source unit for emitting laser light of a red wavelength band, a green wavelength band, or a blue wavelength band, as necessary, and the laser light of each wavelength band emitted from the respective light source units is combined by a prism mirror. In the following combination examples, a light source unit for emitting laser light of a yellow wavelength band may be added.

In the diagrams of FIG. 5 and thereafter, light source units attached with the symbols “B”, “M”, “U” respectively show light source units to be disposed in the bottom row, the middle row, and the upper row. Similarly, prism mirrors attached with the symbols “B”, “M”, and “U” respectively show prism mirrors to be disposed in the bottom row, the middle row, and the upper row.

In the following, combination examples of combining light by a prism mirror are described. In any one of the following combination examples, the propagating directions of light emitted from light source units can be aligned with one direction, and high luminance of illumination light in one direction can be realized.

### Combination Example 1-1

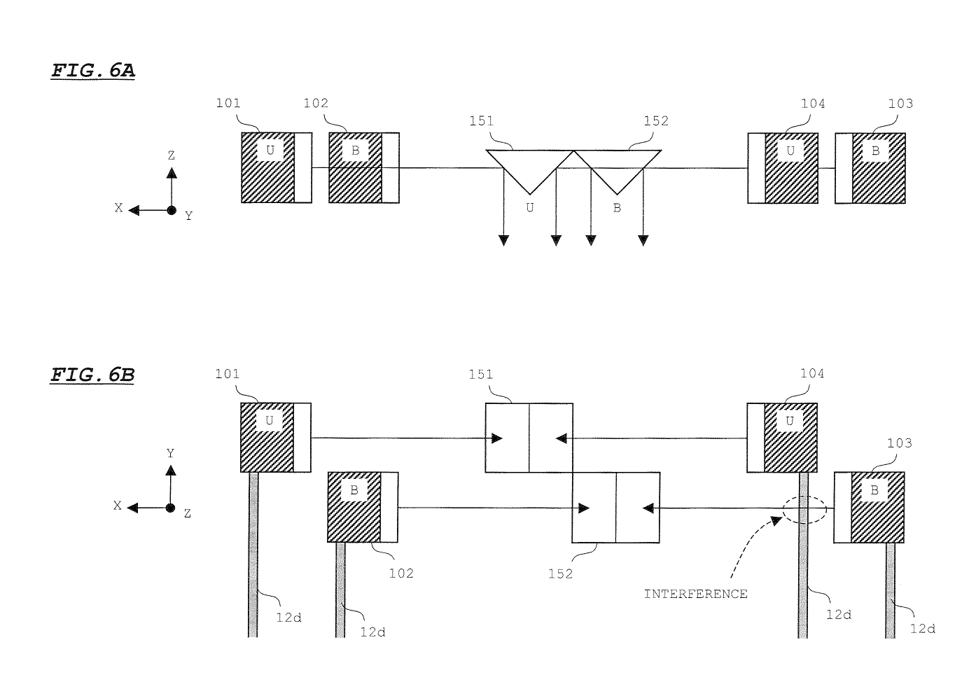

FIG. 5, FIG. 6A and FIG. 6B are diagrams showing a combination example, wherein four light source units 101 through 104 are opposed to each other in X-axis direction, and laser light is reflected in Z-axis direction by two prism mirrors 151 and 152. FIG. 6A is a top plan view of FIG. 5, and FIG. 6B is a front view of FIG. 5.

In this combination example, the light source units 101 and 102 are disposed at forward and rearward positions in the light emission direction, and the rearward light source unit 101 is displaced in upward direction with respect to the forward light source unit 102 by a predetermined distance. Further, the light source units 103 and 104 are disposed at forward and rearward positions in the light emission direction, and the rearward light source unit 103 is displaced in downward direction with respect to the forward light source unit 104 by a predetermined distance. The polarization directions of laser light to be emitted from the light source units 101 through 104 are aligned with one direction. Accordingly, the polarization directions of laser light after reflection on the prism mirrors 151 and 152 are also aligned with one direction. In all the following combination examples, the polarization directions of laser light are aligned with one direction, as well as this combination example.

In this combination example, the optical path lengths from the light source units 101 through 104 to mirror surfaces of the corresponding prism mirrors 151 and 152 can be made equal to each other. Accordingly, it is possible to align the beam shapes of two laser light after reflection on the prism mirror 151, and also possible to align the beam shapes of two laser light after reflection on the prism mirror 152. However, in this combination example, since laser light from the light source unit 103 interferes with the plumbing pipes 12d for the light source unit 104, laser light from the light source unit 103 may be deteriorated. It is desirable to dispose light source units at such positions as to avoid interference between laser light and the plumbing pipes 12d in order to stabilize illumination light.

### Combination Example 1-2

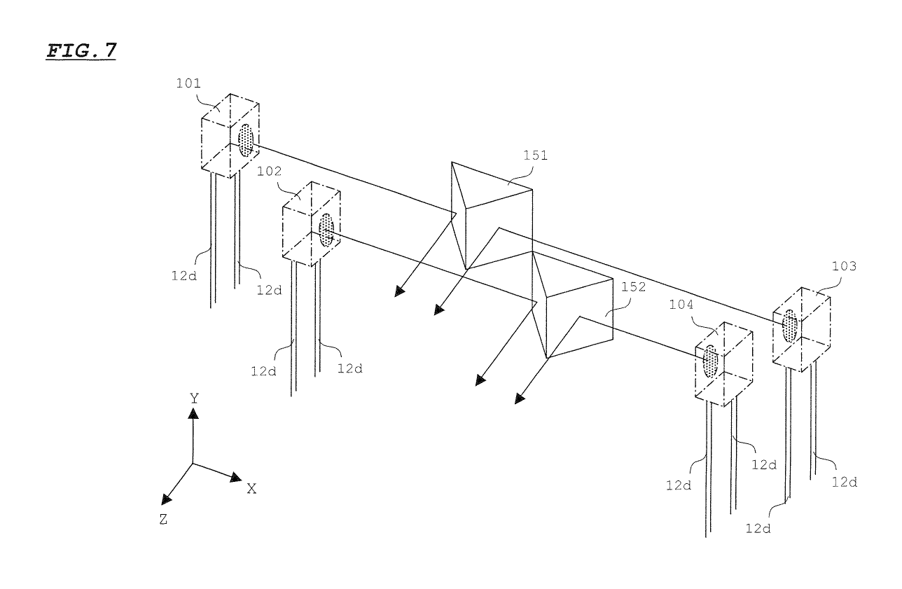

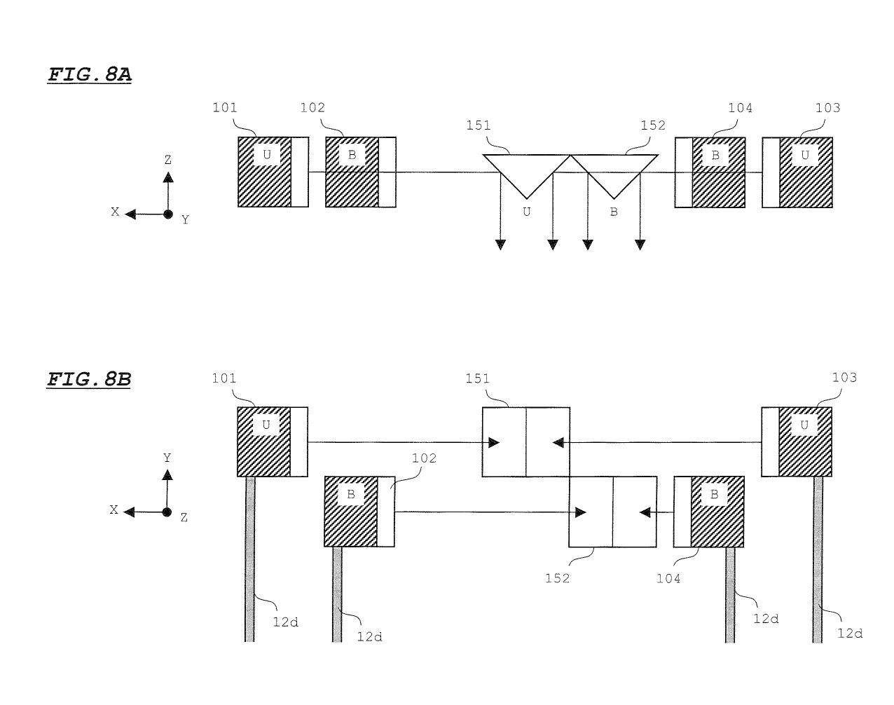

FIG. 7, FIG. 8A and FIG. 8B are diagrams showing a combination example, wherein the dispositions of the light source units shown in FIG. 5, FIG. 6A, and FIG. 6B are adjusted to avoid interference between laser light and the plumbing pipes 12d. FIG. 8A is a top plan view of FIG. 7, and FIG. 8B is a front view of FIG. 7.

In this combination example, the light source units 103 and 104 are disposed at forward and rearward positions in the light emission direction, and the rearward light source unit 103 is displaced in upward direction with respect to the forward light source unit 104 by a predetermined distance. In the above arrangement, there is no likelihood that laser light from the light source unit 103 may be blocked by the plumbing pipes 12d for the light source unit 104, and it is possible to smoothly allow incidence of laser light from all the light source units 101 through 104 into the corresponding prism mirrors 151 and 152. Thus, it is possible to supply stable illumination light to the optical system 20, without deterioration of laser light resulting from interference with the plumbing pipes 12d.

In this combination example, by disposing the light source units 101 and 102, and disposing the light source units 103 and 104 as shown in FIG. 4E, as described referring to FIG. 4E, it is possible to reduce the overall size of a light flux obtained by combining laser light from the two laser light sources, and enhance the light use efficiency based on Etendue theory.

### Combination Example 1-3

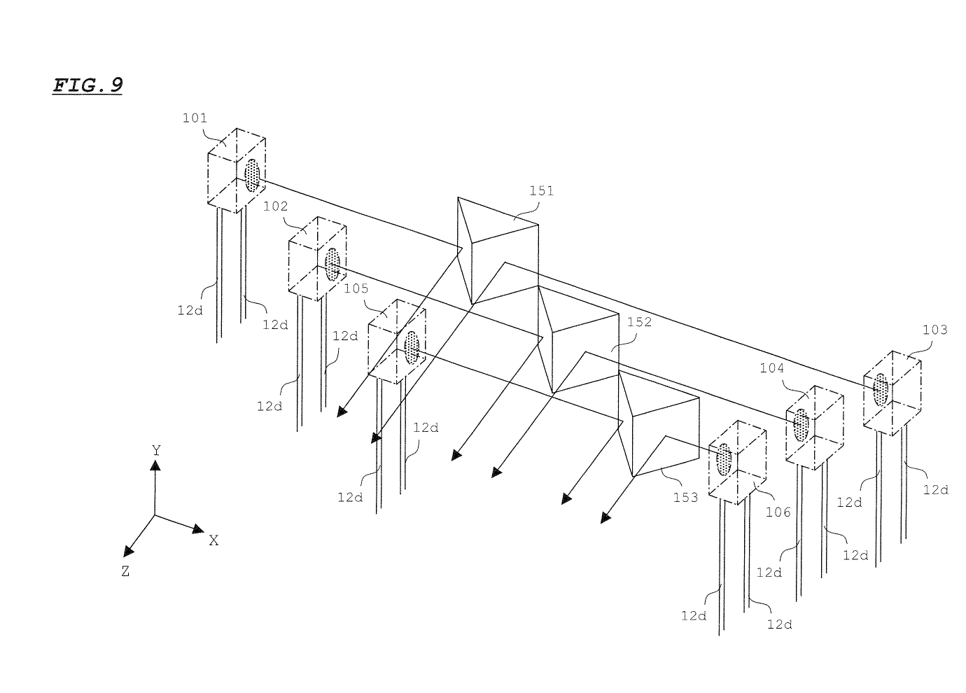

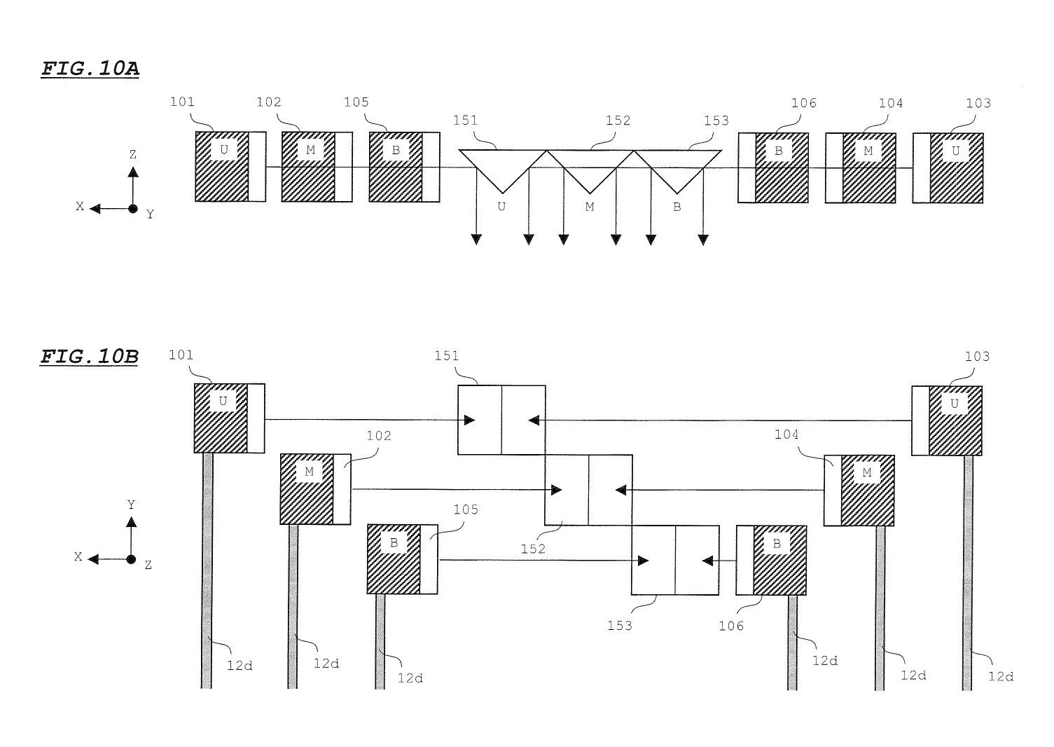

FIG. 9, FIG. 10A and FIG. 10B are diagrams showing a combination example, wherein six light source units 101 through 106 are opposed to each other in X-axis direction, and laser light is reflected in Z-axis direction by three prism mirrors 151, 152 and 153. FIG. 10A is a top plan view of FIG. 9, and FIG. 10B is a front view of FIG. 9.

In this combination example, the light source units 101, 102 and 105 are disposed at forward and rearward positions in the light emission direction, and the rearward light source units 101 and 102 are displaced gradually in upward direction with respect to the forward light source unit 105 by a predetermined distance. Further, the light source units 103, 104 and 106 are disposed at forward and rearward positions in the light emission direction, and the rearward light source units 103 and 104 are displaced gradually in upward direction with respect to the forward light source unit 106 by a predetermined distance. The polarization directions of laser light to be emitted from the light source units 101 through 106 are aligned with one direction. Accordingly, the polarization directions of laser light after reflection on the prism mirrors 151, 152 and 153 are also aligned with one direction.

In the above arrangement, there is no likelihood that laser light from the light source units 101 and 103 may be blocked by the plumbing pipes 12d for the light source units 102 and 104 disposed in front of the light source units 101 and 103. Furthermore, there is no likelihood that laser light from the light source units 102 and 104 may be blocked by the plumbing pipes 12d for the light source units 105 and 106 disposed in front of the light source units 102 and 104. Therefore it is possible to smoothly allow incidence of laser light from all the light source units 101 through 104 into the corresponding prism mirrors 151, 152 and 152. Thus, it is possible to supply stable illumination light to the optical system 20, without deterioration of laser light resulting from interference with the plumbing pipes 12d.

In this combination example, by disposing the light source units 101 and 102, disposing the light source units 102 and 105, disposing the light source units 103 and 104, and disposing the light source units 104 and 106, as shown in FIG. 4E, as described referring to FIG. 4E, it is possible to reduce the overall size of a light flux obtained by combining laser light from the two laser light sources, and enhance the light use efficiency based on Etendue theory.

### Combination Example 1-4

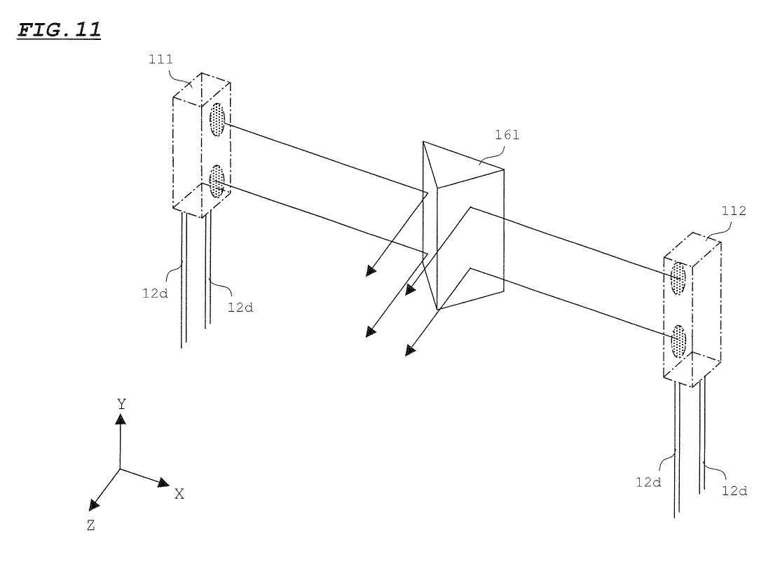

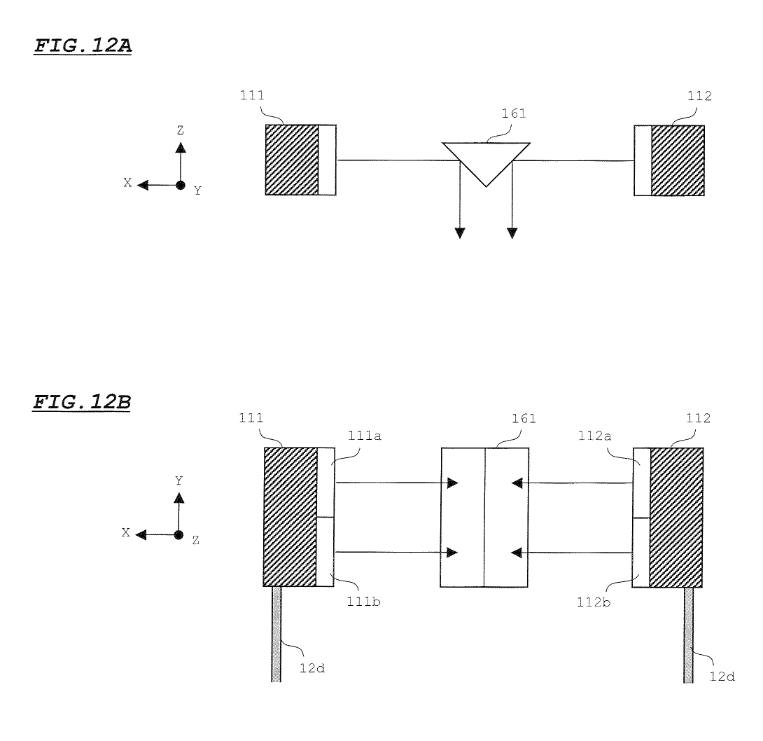

FIG. 11, FIG. 12A and FIG. 12B are diagrams showing a combination example, wherein light source units 111 and 112 shown in FIG. 4F are opposed to each other in X-axis direction, and laser light is reflected in Z-axis direction by prism mirror 161. FIG. 12A is a top plan view of FIG. 11, and FIG. 12B is a front view of FIG. 11.

In this combination example, it is possible to reduce the distance between the laser light sources 111a and 111b and the distance between the laser light sources 112a and 112b, as compared with the combination example in FIGS. 7, 8A and 8B. Therefore, as described referring to FIG. 4F, it is possible to reduce the overall size of a light flux obtained by combining laser light from the two laser light sources, and enhance the light use efficiency based on Etendue theory. In this combination example, since one cooling portion is mounted with respect to two laser light sources, it is possible to simplify the arrangement. However, since a cooling operation is performed by two laser light sources as a pair, it is impossible to individually control the temperatures of the light sources. Accordingly, the combination example shown in FIG. 7, FIG. 8A, and FIG. 8B is superior in the aspect of temperature control.

### Combination Example 1-5

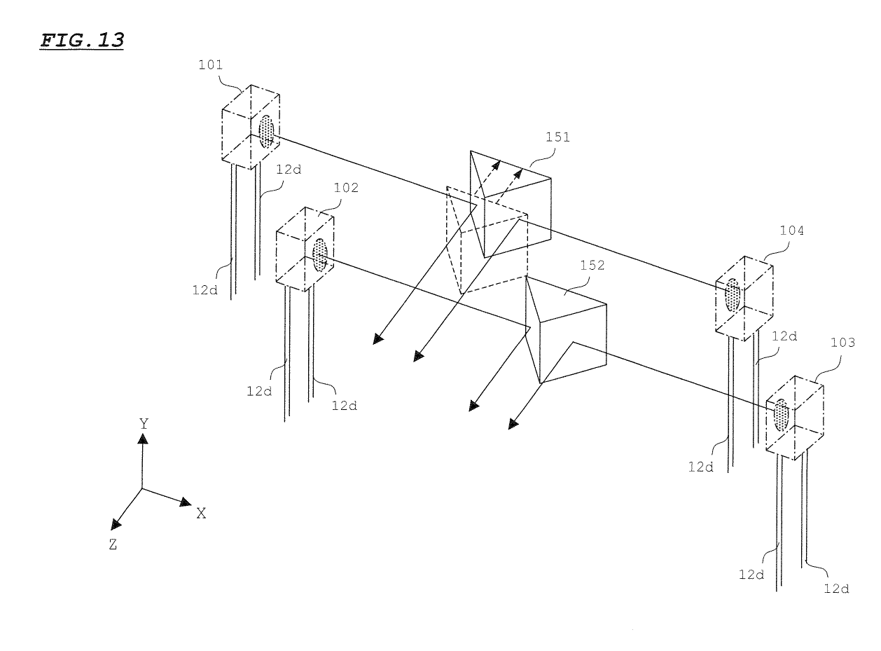

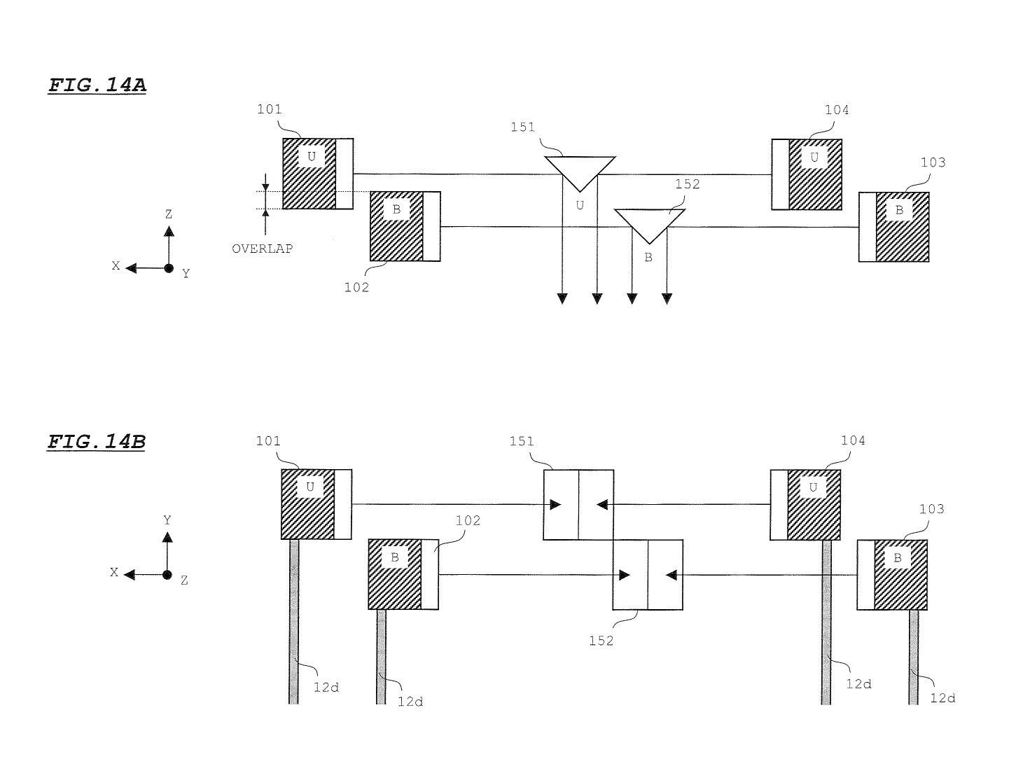

FIG. 13, FIG. 14A, and FIG. 14B are diagrams showing a combination example, wherein the light source units 101 and 104, and the prism mirror 151 in the combination example shown in FIG. 5, FIG. 6A, and FIG. 6B are displaced in Z-axis direction by a predetermined distance. FIG. 14A is a top plan view of FIG. 13, and FIG. 14B is a front view of FIG. 13.

In this combination example, since the light source units 101 and 104, and the prism mirror 151 are displaced in Z-axis direction by a predetermined distance, it is possible to avoid the problem in the combination example shown in FIG. 5, FIG. 6A, and FIG. 6B, in other words, interference between laser light from the light source unit 103, and the plumbing pipes 12d for the light source unit 104. Thus, it is possible to suppress deterioration of illumination light.

In addition, in this combination example, the optical path lengths from the light source units 101 through 104 to mirror surfaces of the corresponding prism mirrors 151 and 152 can be made equal to each other. Accordingly, it is possible to align the beam shapes of two laser light after reflection on the prism mirror 151, and also possible to align the beam shapes of two laser light after reflection on the prism mirror 152.

In this combination example, the light source units 101 and 102 are partially overlapped with each other in Z-axis direction, and the light source units 103 and 104 are also partially overlapped with each other in Z-axis direction. This arrangement is advantageous in reducing the optical path difference between laser light from the light source units 101 and 103, and laser light from the light source units 102 and 104, as compared with an arrangement, wherein light source units are disposed without being overlapped with each other. Accordingly, it is possible to reduce the size difference between the beam shape of laser light from the light source units 101 and 103 after reflection on the prism mirror 151, and the beam shape of laser light from the light source units 102 and 104 after reflection on the prism mirror 152, and enhance uniformity of illumination light.

In this combination example, furthermore, by partially overlapping the light source units 101 and 102 with each other in Y-axis direction, and partially overlapping the light source units 103 and 104 with each other in Y-axis direction, it is possible to reduce the overall size of a light flux obtained by combining laser light from two light source units, and enhance the light use efficiency of illumination light based on Etendue theory.

### Combination Example 1-6

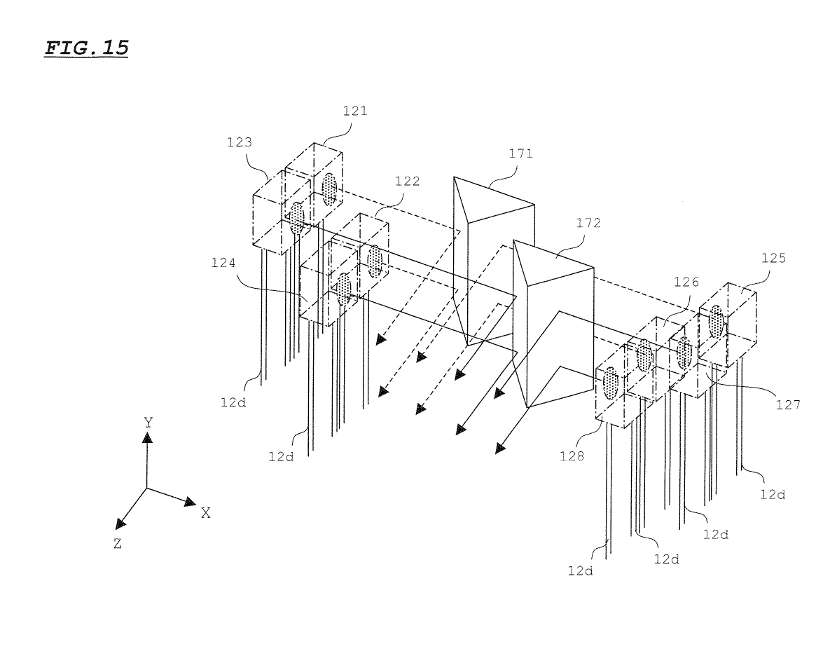

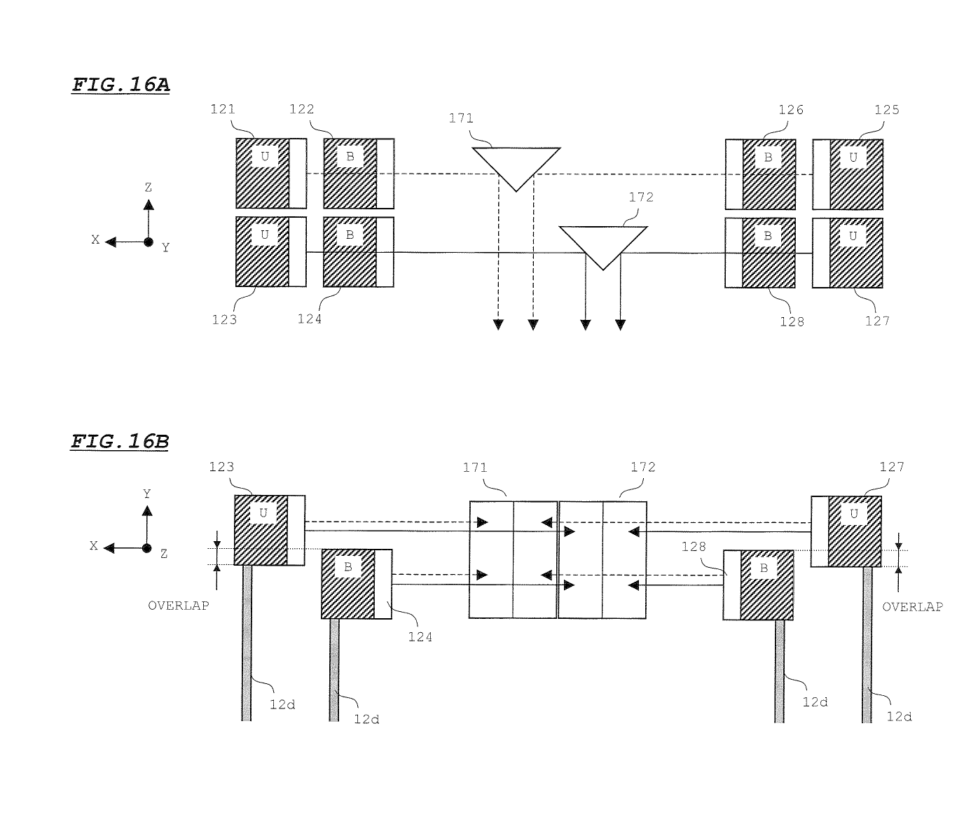

FIG. 15, FIG. 16A and FIG. 16B are diagrams showing a combination example, wherein eight light source units 121 through 128 are opposed to each other in X-axis direction, and laser light is reflected in Z-axis direction by two prism mirrors 171 and 172. FIG. 16A is a top plan view of FIG. 15, and FIG. 16B is a front view of FIG. 15.

In this combination example, the light source units 121 and 122, the light source units 123 and 124, the light source units 125 and 126, and the light source units 127 and 128 are respectively disposed at forward and rearward positions in X-axis direction. The rearward light source units 121, 123, 125 and 127 are displaced in upward direction with respect to the forward light source units 122, 124, 126 and 128 by a predetermined distance. Further, the light source units 121 and 123, the light source units 122 and 124, the light source units 125 and 127, and the light source units 126 and 128 are disposed side by side in Z-axis direction.

In the above arrangement, there is no likelihood that laser light from the light source units 121, 123, 125 and 127 may be blocked by the plumbing pipes 12d for the light source units 122, 124, 126 and 128 disposed in front of the light source units 121, 123, 125 and 127. Therefore it is possible to smoothly allow incidence of laser light from all the light source units 121 through 128 into the corresponding prism mirrors 171 and 172. Thus, it is possible to supply stable illumination light to the optical system 20, without deterioration of laser light resulting from interference with the plumbing pipes 12d.

Further, in this combination example, the light source units 121 and 122, the light source units 123 and 124, the light source units 125 and 126, and the light source units 127 and 128 are disposed in a partially overlapped state in Y-axis direction, as shown in FIG. 4E. Accordingly, as described referring to FIG. 4E, it is possible to reduce the overall size of a light flux obtained by combining laser light from two light source units, and enhance the light use efficiency of illumination light based on Etendue theory. Further, by partially overlapping the forward and rearward light source units with each other in Y-axis direction as described above, it is possible to reduce the sizes of the prism mirrors 171 and 172 in Y-axis direction.

In this combination example, by replacing light source units disposed side by side in Z-axis direction, specifically, the light source units 121 and 123, the light source units 122 and 124, the light source units 125 and 127, and the light source units 126 and 128 with the arrangement example shown in FIG. 4C, as described referring to FIG. 4C, it is possible to further reduce the overall size of a light flux obtained by combining laser light from two light source units, and further enhance the light use efficiency of illumination light based on Etendue theory.

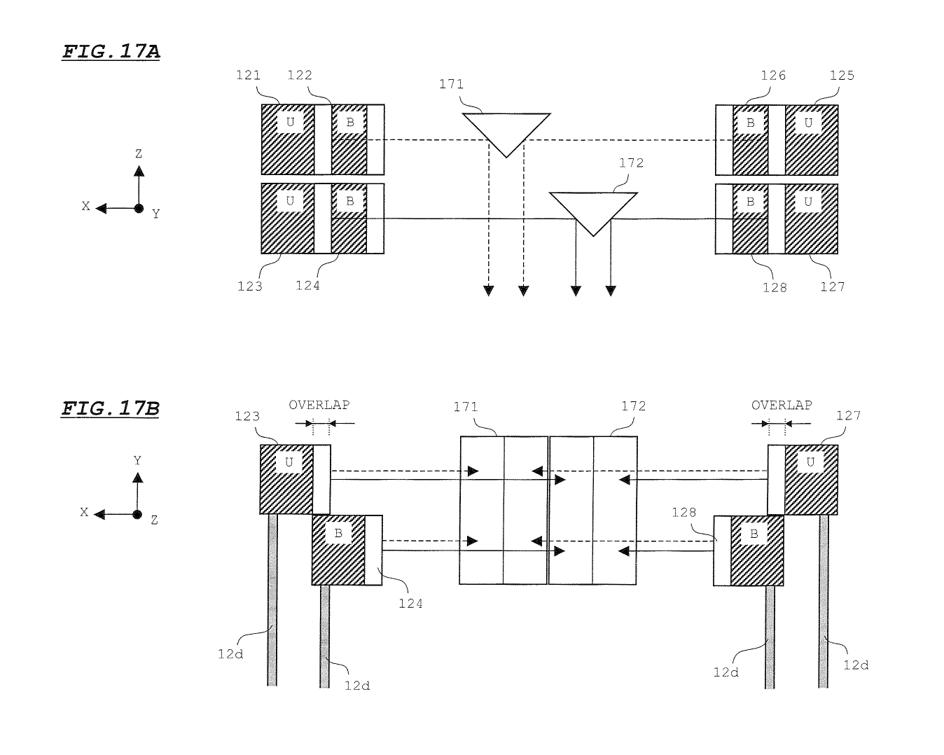

Further, in this combination example, the forward and rearward light source units are disposed in a partially overlapped state in Y-axis direction. Alternatively, as shown in FIGS. 17A and 17B, it is possible to dispose the forward and rearward light source units in a partially overlapped state in X-axis direction. The modification enables to reduce the optical path difference between laser light from two light source units at forward and rearward positions in X-axis direction, and reduce the size difference between the beam shapes of laser light after reflection on the prism mirrors 171 and 172. As a result, it is possible to enhance uniformity of illumination light.

### Combination Example 1-7

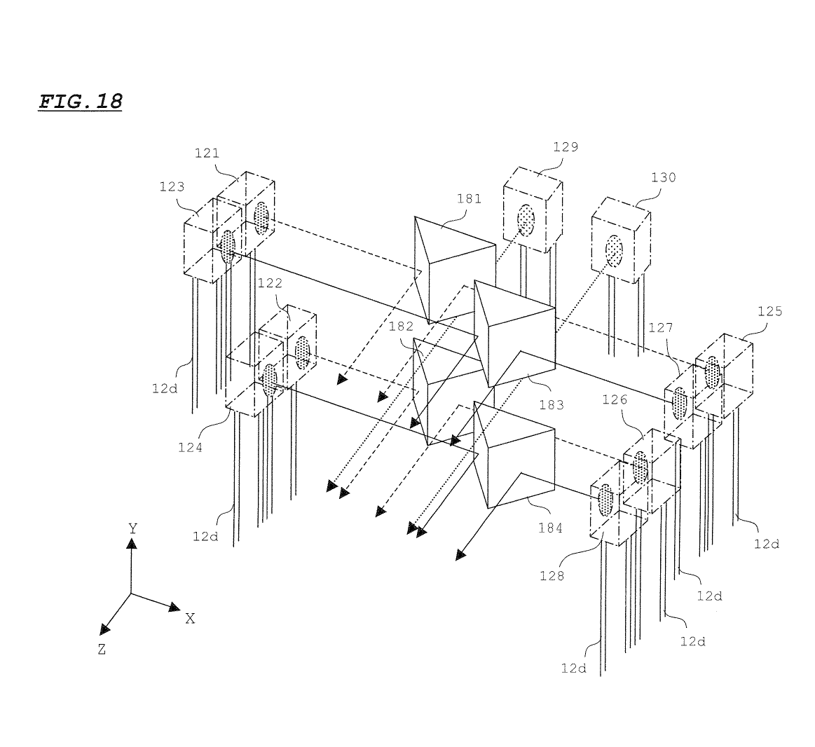

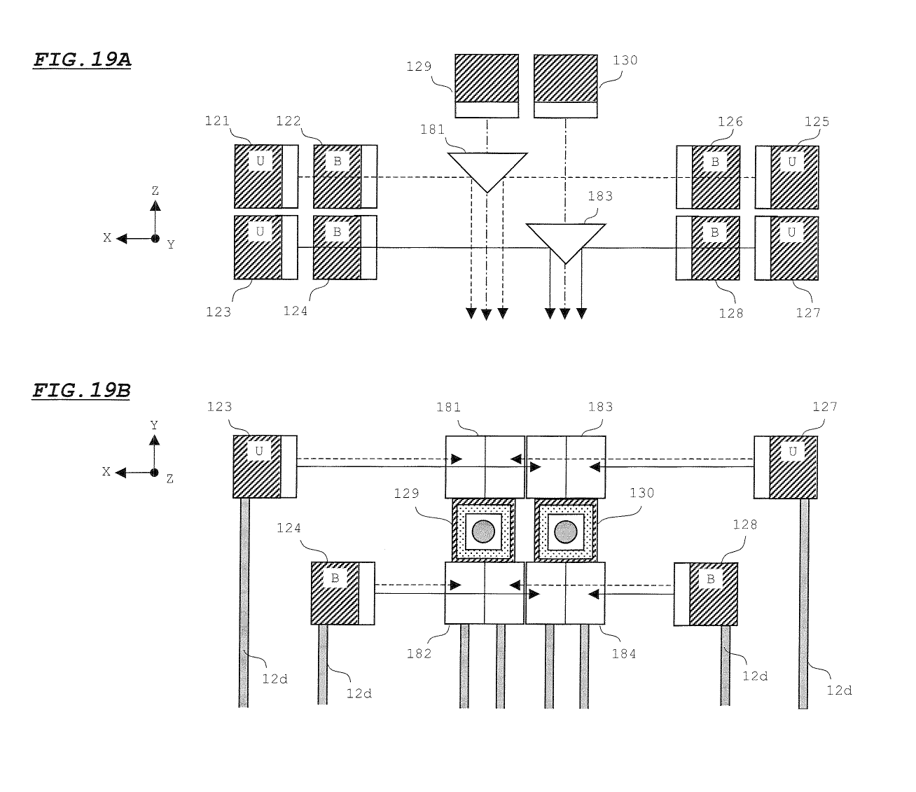

FIG. 18, FIG. 19A, and FIG. 19B are diagrams showing a combination example, wherein eight light source units 121 through 128 are opposed to each other in X-axis direction, laser light from the light source units 121 through 128 is reflected in Z-axis direction by four prism mirrors 181 through 184, and two light source 129 and 130 are disposed on the back surface side of the prism mirrors 181 through 184 to emit two laser light from the light source units 129 and 130 respectively through a clearance between the prism mirrors 181 and 182, and through a clearance between the prism mirrors 183 and 184 in Z-axis direction. FIG. 19A is a top plan view of FIG. 18, and FIG. 19B is a front view of FIG. 18.

In this combination example, the light source units 121 and 122, the light source units 123 and 124, the light source units 125 and 126, and the light source units 127 and 128 are respectively disposed at forward and rearward positions in X-axis direction. The rearward light source units 121, 123, 125 and 127 are displaced in upward direction with respect to the forward light source units 122, 124, 126 and 128 by a predetermined distance. Further, the light source units 121 and 123, the light source units 122 and 124, the light source units 125 and 127, and the light source units 126 and 128 are disposed side by side in Z-axis direction.

In the above arrangement, there is no likelihood that laser light from the light source units 121, 123, 125 and 127 may be blocked by the plumbing pipes 12d for the light source units 122, 124, 126 and 128 disposed in front of the light source units 121, 123, 125 and 127. Therefore it is possible to smoothly allow incidence of laser light from all the light source units 121 through 128 into the corresponding prism mirrors 181 through 184. Thus, it is possible to supply stable illumination light to the optical system 20, without deterioration of laser light resulting from interference with the plumbing pipes 12d. Further, in this combination example, since the two light source units 129 and 130 are additionally provided, the luminance of illumination light can be further increased, as compared with the combination example shown in FIG. 15, FIG. 16A, and FIG. 16B.

Similarly to the combination example in FIGS. 15, 16A and 16B, in this combination example, by replacing light source units disposed side by side in Z-axis direction, specifically, the light source units 121 and 123, the light source units 122 and 124, the light source units 125 and 127, and the light source units 126 and 128 with the arrangement example shown in FIG. 4C, as described referring to FIG. 4C, it is possible to further reduce the overall size of a light flux obtained by combining laser light from two light source units, and further enhance the light use efficiency of illumination light based on Etendue theory. Further, similarly to the combination example in FIGS. 17A and 17B, by disposing two light source units at forward and rearward positions in X-axis direction in a partially overlapped state in X-axis direction, it is possible to enhance the light use efficiency of illumination light in the optical system 20.

### Combination Example 1-8

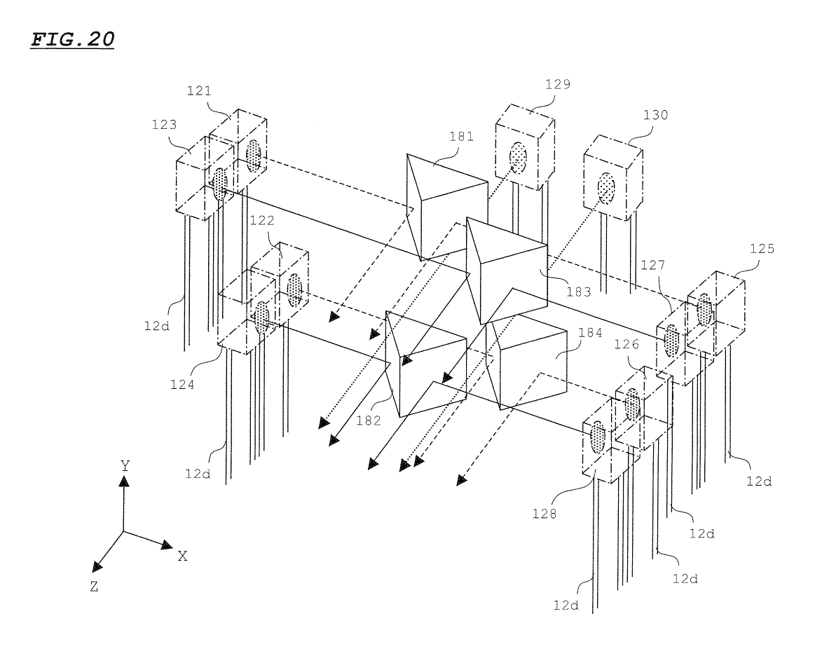

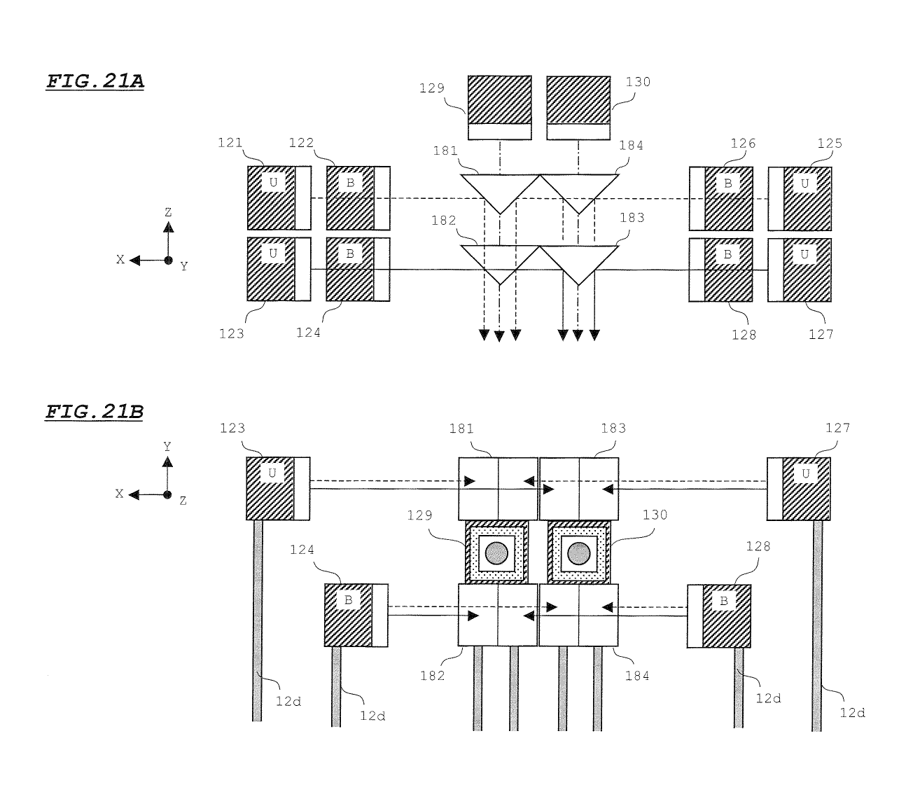

FIG. 20, FIG. 21A, and FIG. 21B are diagrams showing a combination example, wherein the dispositions of the prism mirrors 181 through 184 in the combination example shown in FIG. 18, FIG. 19A, and FIG. 19B are modified. FIG. 21A is a top plan view of FIG. 20, and FIG. 21B is a front view of FIG. 20.

This combination example is different from the combination example shown in FIG. 18, FIGS. 19A, and 19B in the positions of the prism mirrors 182 and 184. Specifically, laser light from the light source units 122 and 126 is reflected on the prism mirror 184, and laser light from the light source units 124 and 128 is reflected on the prism mirror 182.

In this combination example, substantially the same advantage as in the combination example shown in FIG. 18, FIGS. 19A, and 19B is obtained. Further, in this combination example, as well as the combination example shown in FIG. 18, FIG. 19A, and FIG. 19B, by replacing the light source units disposed side by side in Z-axis direction with the arrangement example shown in FIG. 4C, it is possible to enhance the light use efficiency of illumination light; and by disposing two light source units at forward and rearward positions in X-axis direction in a partially overlapped state in X-axis direction, it is possible to enhance the light use efficiency of illumination light in the optical system 20.

### Combination Example 1-9

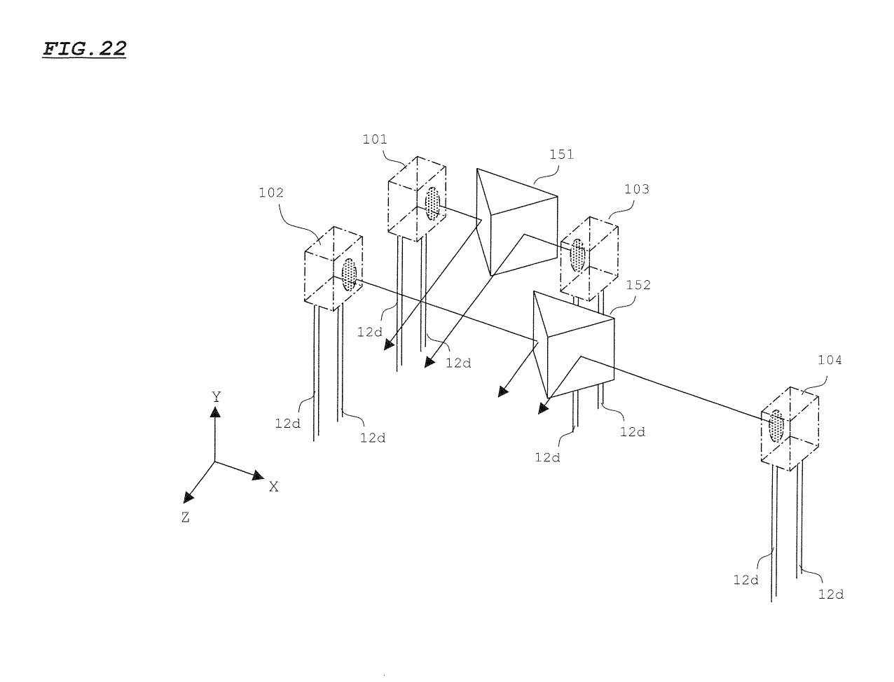

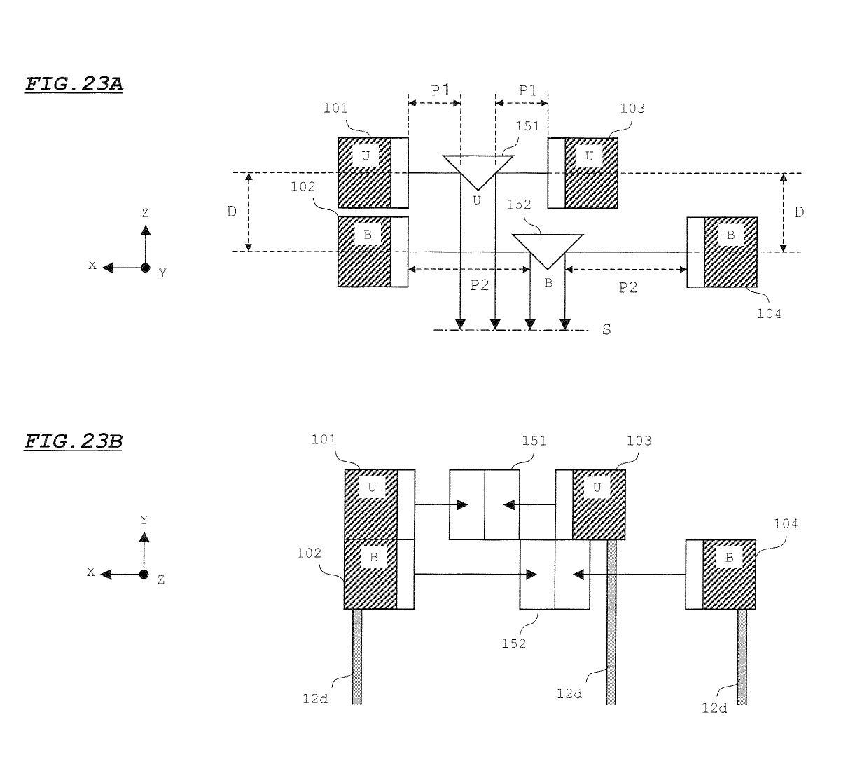

FIG. 22, FIG. 23A and FIG. 23B are diagrams showing a combination example, wherein four light source units 101 through 104 are opposed to each other in X-axis direction, and laser light is reflected in Z-axis direction by two prism mirrors 151 and 152. FIG. 23A is a top plan view of FIG. 22, and FIG. 23B is a front view of FIG. 22.

In this combination example, the light source units 101 through 104, and the prism mirrors 151 and 152 are disposed at such positions that the optical path lengths from the light source units 101 through 104 to a plane S perpendicular to the optical axes of laser light after reflection on the prism mirror 151 and 152 are made equal to each other. Specifically, referring to FIG. 23A, the dispositions of the light source units 101 through 104, and the prism mirrors 151 and 152 are adjusted to satisfy a relation: P1+D=P2, where P1 is a distance from the light source units 101 and 103 to a reflection surface of the prism mirror 151, P2 is a distance from the light source units 102 and 104 to a reflection surface of the prism mirror 152, and D is a distance in Z-axis direction between the light source units 101 and 102, and a distance in Z-axis direction between the light source units 103 and 104.

As described above, in this combination example, since the optical path lengths from the light source units 101 through 104 to the plane S perpendicular to the optical axes of laser light after reflection on the prism mirrors 151 and 152 are made equal to each other, it is possible to align the beam shapes of all the laser light after reflection on the prism mirrors 151 and 152. As a result, it is possible to enhance uniformity of illumination light.

### B. Second Embodiment

This embodiment is directed to an arrangement, wherein a cooling device 30 is disposed in an upper position with respect to an optical system 20. In this embodiment, since the cooling device 30 is disposed in an upper position with respect to the optical system 20, a cooling device of air-cooling type is used as the cooling device 30, and a heat pipe is used as a heat transfer system. Thus, by using a cooling device and a heat transfer system of a type other than liquid-cooling type, it is possible to avoid a drawback resulting from liquid leakage.

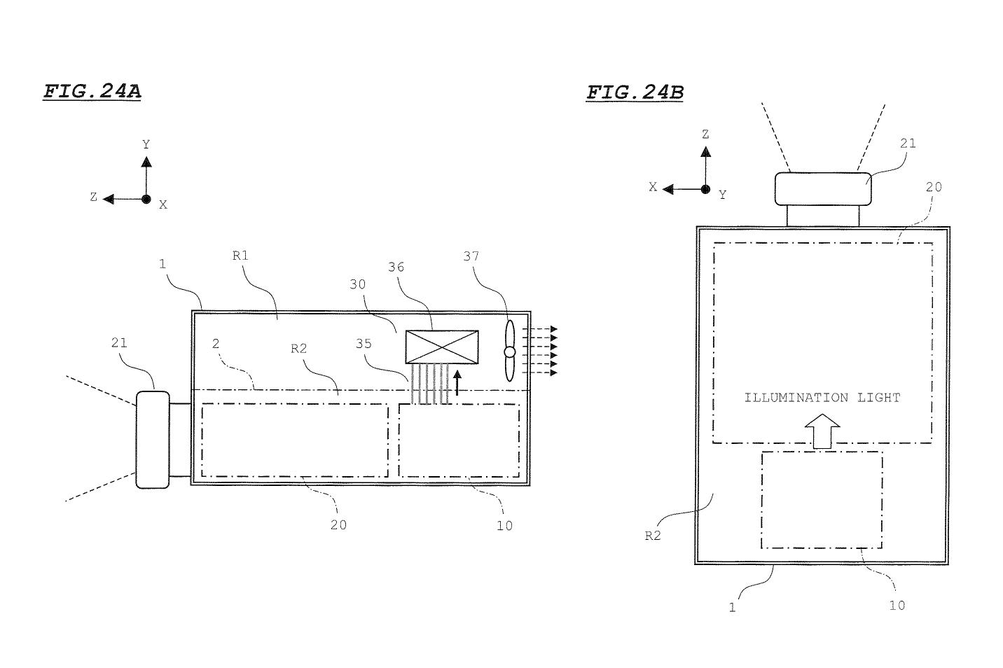

FIGS. 24A and 24B show an arrangement of a projector as the second embodiment. FIG. 24A is a perspective side view of the projector, and FIG. 24B is a perspective view of the projector, when viewed from a bottom side thereof.

Referring to FIGS. 24A and 24B, similarly to the first embodiment, the interior of a projector 1 is divided into a space R1 in the upper position and a space R2 in the lower position by a partition plate 2. The optical system 20, and an illumination device 10 for supplying illumination light to the optical system 20 are disposed in the space R2.

The cooling device 30 is disposed at a position immediately above the illumination device 10 in the space R1 . The cooling device 30 is provided with a heat pipe 35, a heat sink 36, and a fan 37. The heat pipe 35 is connected to a Peltier element 12b (see FIGS. 2A, 2B, 2C, 2D, and FIGS. 3A, 3B, 3C) on the side of a light source unit. Specifically, in this embodiment, the elements in the arrangements shown in FIGS. 2A, 2B, 2C, 2D, and FIGS. 3A, 3B, 3C, 3D except for the liquid cooling jacket 12c and the plumbing pipes 12d are provided, and the heat pipe 35 is mounted on the Peltier element 12b. The heat pipe 35 is mounted on the Peltier element 12b in such a manner that the heat pipe 35 extends upward from the Peltier element 12b.

A heat generated in a laser light source is transferred to the heat sink 36 by the heat pipe 35. The heat transferred to the heat sink 36 is removed by the air supplied to the heat sink 36 by the fan 37. Thus, the heat generated in the laser light source is released to the exterior, and the temperature of the laser light source is adjusted to a predetermined temperature.

In this embodiment, since the heat transfer direction is made upside down with respect to the arrangement example (first embodiment) shown in FIGS. 1A and 1B, it is necessary to make the positional relation of the light source units in the combination examples shown in FIGS. 5 through 23B upside down, and resultantly make the positional relation of the prism mirrors upside down, in order to avoid interference between laser light and the heat pipe 35.

In the following, combination examples of this embodiment, wherein the combination examples shown in FIGS. 5 through 23B in the first embodiment are applied to this embodiment by making the dispositions of the light source units, and the dispositions of the prism mirrors upside down (inverted in Y-axis direction), are described one by one referring to the drawings. In the following, to simplify the description, only a top plan view and a front view of each of the combination examples are shown, and a perspective view thereof is omitted.

### Combination Example 2-1

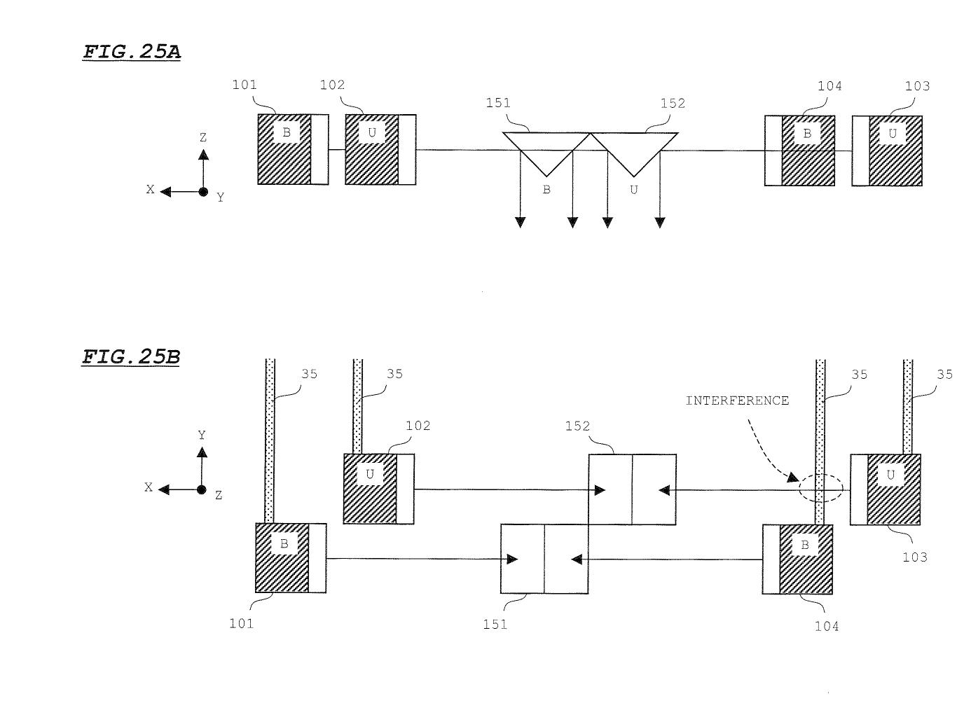

FIGS. 25A and 25B are diagrams showing a combination example, wherein the combination example (first embodiment) shown in FIG. 5, FIGS. 6A, and 6B is applied to this embodiment. In this combination example, as well as the combination example shown in FIG. 5, FIG. 6A, and FIG. 6B, since laser light from the light source unit 103 interferes with the heat pipe 35 mounted on the light source unit 104, laser light from the light source unit 103 may be deteriorated.

### Combination Example 2-2

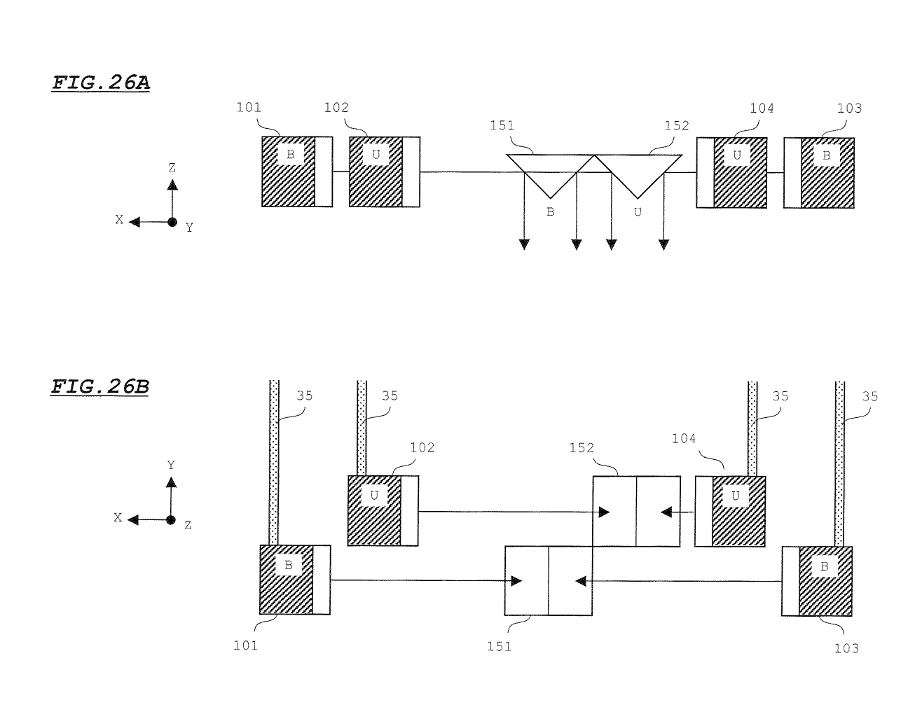

FIGS. 26A and 26B are diagrams showing a combination example, wherein the combination example (first embodiment) shown in FIG. 7, FIGS. 8A, and 8B is applied to this embodiment. In this combination example, as well as the combination example shown in FIG. 7, FIGS. 8A, and 8B, there is no likelihood that laser light from the light source unit 103 may be blocked by the heat pipe 35 mounted on the light source unit 104, and it is possible to smoothly allow incidence of laser light from all the light source units 101 through 104 into the corresponding prism mirrors 151 and 152. Thus, it is possible to supply stable illumination light to the optical system 20, without deterioration of laser light resulting from interference with the heat pipe 35.

As well as the combination example shown in FIG. 7, FIGS. 8A, and 8B, in this combination example, it is also possible to enhance the light use efficiency of illumination light by adjusting the dispositions of the light source units at forward and rearward positions in X-axis direction, as shown in FIG. 4E.

### Combination Example 2-3

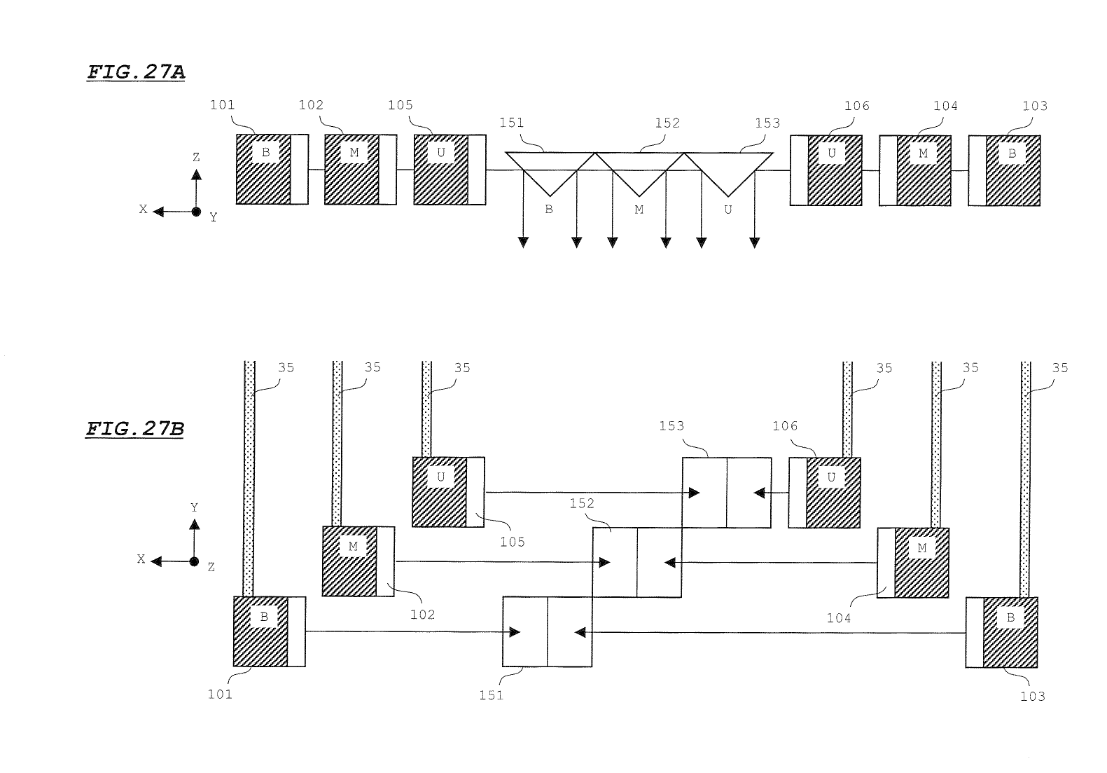

FIGS. 27A and 27B are diagrams showing a combination example, wherein the combination example (first embodiment) shown in FIG. 9, FIGS. 10A, and 10B is applied to this embodiment. In this combination example, as well as the combination example shown in FIG. 9, FIGS. 10A, and 10B, there is no likelihood that laser light from the light source units 101 and 103 may be blocked by the heat pipe 35 mounted on the light source units 102 and 104 that are disposed in front of the light source units 101 and 103. In addition, there is no likelihood that laser light from the light source units 102 and 104 may be blocked by the heat pipe 35 mounted on the light source units 105 and 106 that are disposed in front of the light source units 102 and 104. Therefore, it is possible to smoothly allow incidence of laser light from all the light source units 101 through 106 into the corresponding prism mirrors 151, 152 and 153. Thus, it is possible to supply stable illumination light to the optical system 20.

As well as the combination example shown in FIG. 9, FIGS. 10A, and 10B, in this combination example, it is also possible to enhance the light use efficiency of illumination light by adjusting the dispositions of the light source units at forward and rearward positions in X-axis direction, as shown in FIG. 4E.

### Combination Example 2-4

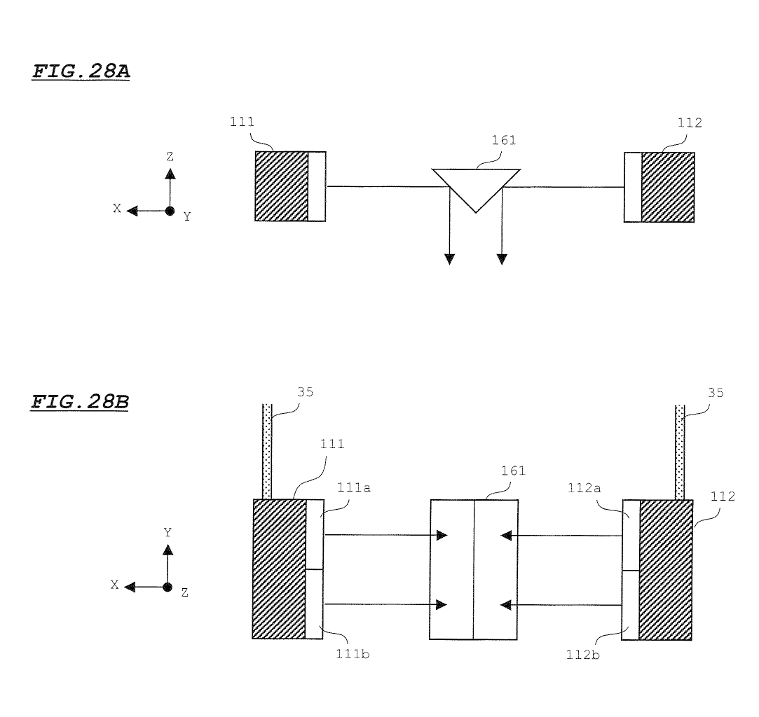

FIGS. 28A and 28B are diagrams showing a combination example, wherein the combination example (first embodiment) shown in FIG. 11, FIG. 12A, and 12B is applied to this embodiment. In this combination example, as well as the combination example shown in FIG. 11, FIG. 12A, and 12B, it is possible to reduce the distance between the laser light sources 111a and 111b and the distance between the laser light sources 112a and 112b. Therefore, it is possible to reduce the overall size of a light flux obtained by combining laser light from the two laser light sources, and enhance the light use efficiency. In this combination example, since one cooling portion is mounted with respect to two laser light sources, it is possible to simplify the arrangement. However, since a cooling operation is performed by two laser light sources as a pair, it is impossible to individually control the temperatures of the light sources.

### Combination Example 2-5

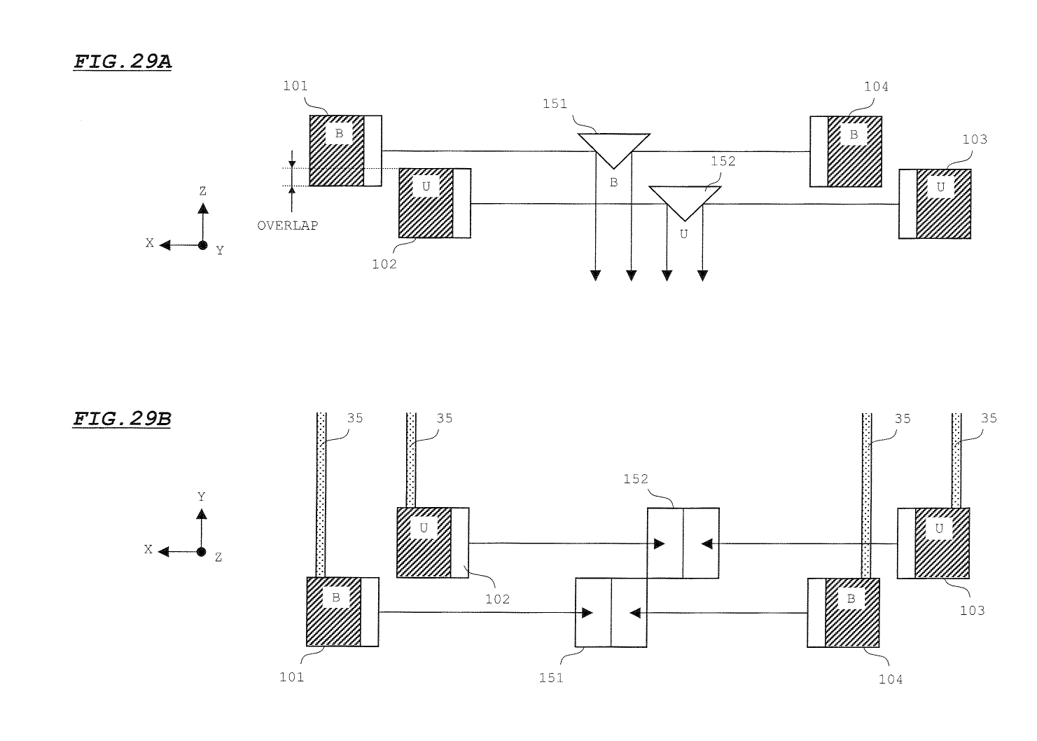

FIGS. 29A and 29B are diagrams showing a combination example, wherein the combination example (first embodiment) shown in FIG. 13, FIG. 14A, and 14B is applied to this embodiment. In this combination example, as well as the combination example shown in FIG. 13, FIG. 14A, and 14B, since the light source units 101 and 104, and the prism mirror 151 are disposed with a displacement in Z-axis direction by a predetermined distance, it is possible to avoid interference between laser light from the light source unit 104, and the heat pipe 35 of the light source unit 103. Accordingly, it is possible to suppress deterioration of illumination light. Further, in this combination example, substantially the same advantage as in the combination example (first embodiment) shown in FIG. 13, FIGS. 14A and 14B is obtained. Further, this combination example may be modified in the similar manner as the combination example (first embodiment) shown in FIG. 13, FIGS. 14A and 14B.

### Combination Example 2-6

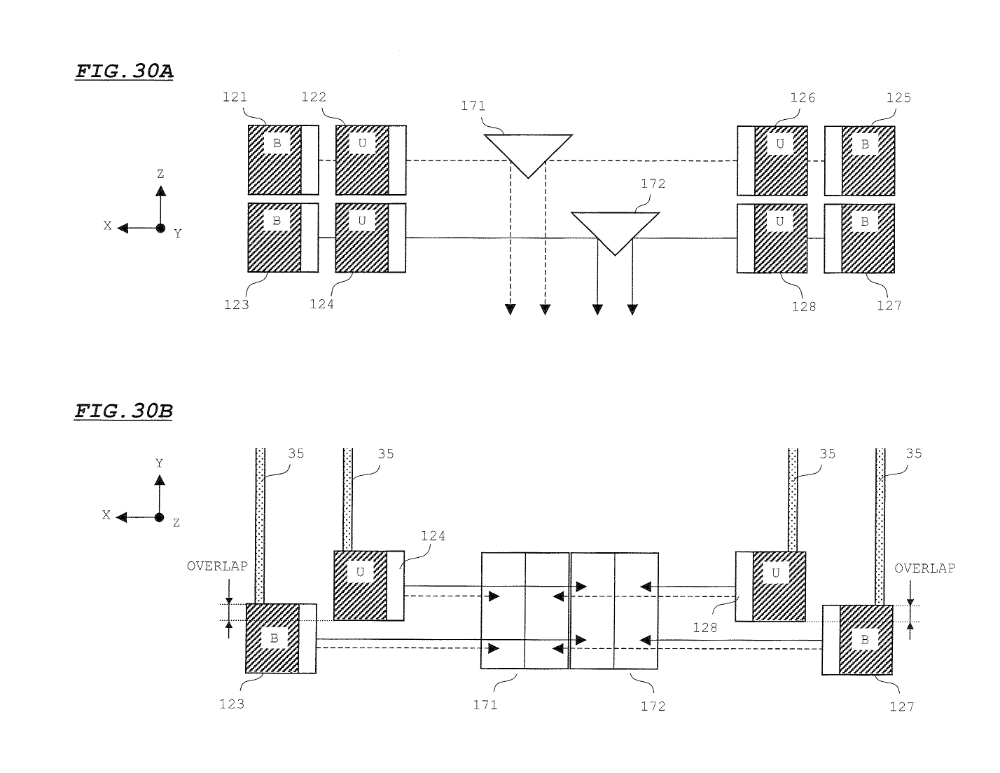

FIGS. 30A and 3013 are diagrams showing a combination example, wherein the combination example (first embodiment) shown in FIG. 15, FIG. 16A, and 16B is applied to this embodiment. In this combination example, as well as the combination example shown in FIG. 15, FIG. 16A, and 1613, there is no likelihood that laser light from the light source units 121, 123, 125 and 127 may be blocked by the heat pipe 35 mounted on the light source units 122, 124, 126 and 128 that are disposed in front of the light source units 121, 123, 125 and 127. Therefore, it is possible to smoothly allow incidence of laser light from all the light source units 121 through 128 into the corresponding prism mirrors 171 and 172. Thus, it is possible to supply stable illumination light to the optical system 20. Further, in this combination example, substantially the same advantage as in the combination example (first embodiment) shown in FIG. 15, FIG. 16A and 16B is obtained. Further, this combination example may be modified in the similar manner as the combination example (first embodiment) shown in FIG. 15, FIGS. 16A and 16B.

### Combination Example 2-7

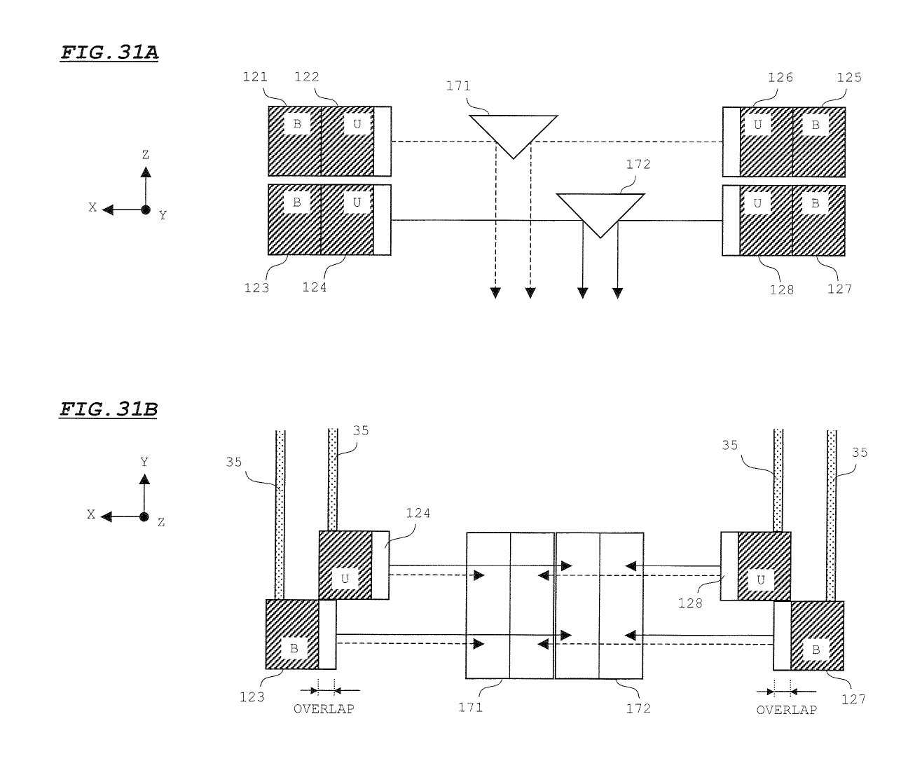

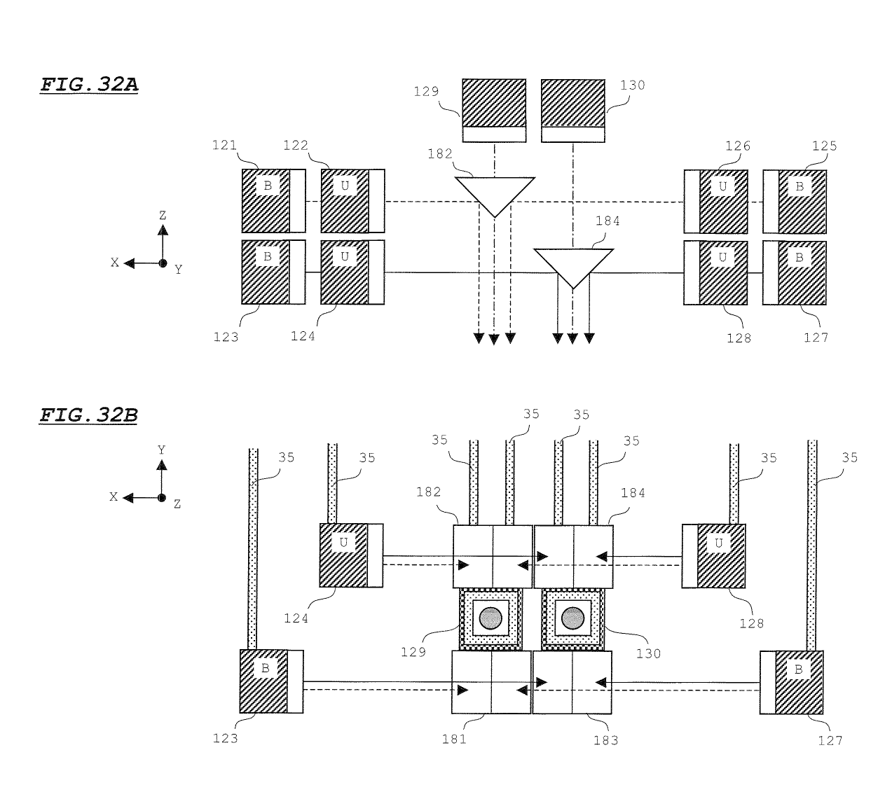

FIGS. 31A and 32B are diagrams showing a combination example, wherein the combination example (first embodiment) shown in FIGS. 17A and 17B is applied to this embodiment. In this combination example, as well as the combination example shown in FIGS. 17A and 17B, it is possible to reduce the optical path difference between laser light from the two light source units, wherein light source units are disposed at forward and rearward positions in X-axis direction, and reduce the size difference between the beam shapes of the laser light after reflection on the prism mirror 171 and 172. Thus, it is possible to enhance the light use efficiency of illumination light in the optical system 20.

### Combination Example 2-8

FIGS. 32A and 32B are diagrams showing a combination example, wherein the combination example (first embodiment) shown in FIG. 18, FIG. 19A, and 19B is applied to this embodiment. In this combination example, as well as the combination example shown in FIG. 18, FIG. 19A, and 19B, there is no likelihood that laser light from the light source units 121, 123, 125 and 127 may be blocked by the heat pipe 35 mounted on the light source units 122, 124, 126 and 128 that are disposed in front of the light source units 121, 123, 125 and 127. Therefore, it is possible to smoothly allow incidence of laser light from all the light source units 121 through 128 into the corresponding prism mirrors 181 through 184. Thus, it is possible to supply stable illumination light to the optical system 20, without deterioration of laser light resulting from interference with the heat pipe 35. Further, in this combination example, substantially the same advantage as in the combination example (first embodiment) shown in FIG. 18, FIG. 19A and 19B is obtained. Further, this combination example may be modified in the similar manner as the combination example (first embodiment) shown in FIG. 18, FIGS. 19A and 19B.

### Combination Example 2-9

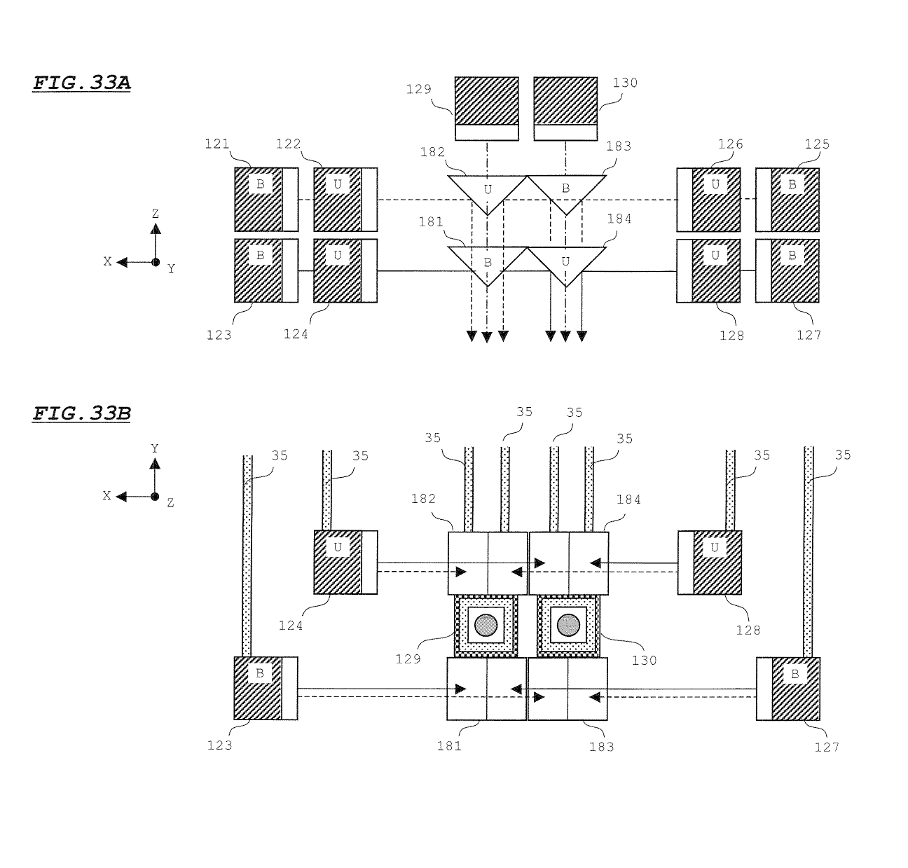

FIGS. 33A and 33B are diagrams showing a combination example, wherein the combination example (first embodiment) shown in FIGS. 20, 21A, and 21B is applied to this embodiment. As well as the combination example shown in FIGS. 20, 21A, and 21B, this combination example is different from the combination example shown in FIGS. 32A and 32B in the positions of the prism mirrors 181 and 183. In this combination example, substantially the same advantage as in the combination example shown in FIGS. 32A and 32B is obtained. Further, this combination example may be modified in the similar manner as the combination example (first embodiment) shown in FIGS. 20, 21A and 21B.

### Combination Example 2-10

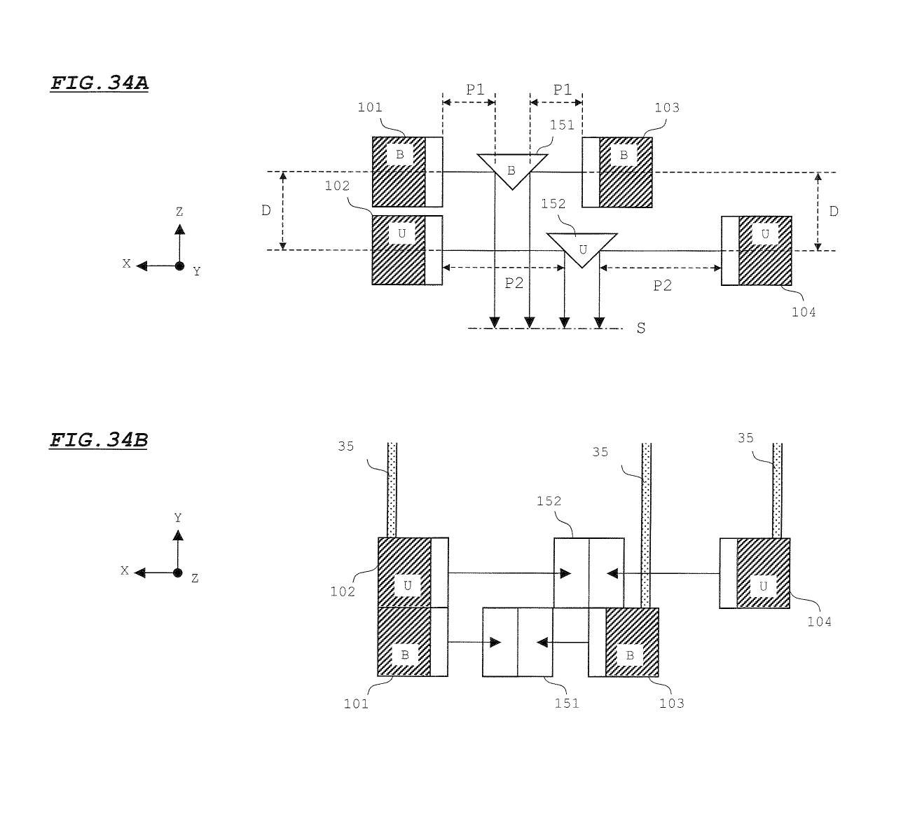

FIGS. 34A and 34B are diagrams showing a combination example, wherein the combination example (first embodiment) shown in FIGS. 22, 23A and 23B is applied to this embodiment. In this combination example, since the optical path lengths from the light source units 101 through 104 to the plane S perpendicular to the optical axes of laser light after reflection on the prism mirrors 151 and 152 are made equal to each other, it is possible to align the beam shapes of all the laser light after reflection on the prism mirrors 151 and 152. As a result, it is possible to enhance uniformity of illumination light.

As described above, in the first embodiment and the second embodiment, since the cooling device 30 is disposed in a lower position or an upper position with respect to the optical system 20, it is possible to reduce the outer size of the projector 1, as compared with an arrangement, wherein a cooling device 30 is disposed in parallel to an installation plane of an optical system 20. Further, since the cooling device 30 is disposed at a position immediately below or immediately above the illumination device 10, it is possible to suppress elongation of the plumbing pipes 12d, 34, and the heat pipe 35, thereby simplifying the arrangement of the heat transfer system and reducing the cost.

Further, it is possible to avoid interference between the plumbing pipe 12d or the heat pipe 35, and laser light, and supply stable illumination light to the optical system 20 by combining laser light in the illumination device 10 in accordance with the combination examples shown in FIGS. 7 through 23B, and the combination examples shown in FIGS. 26A through 34B. Further, as described individually in each of the combination examples, using the combination examples shown in FIGS. 7 through 23B, and the combination examples shown in FIGS. 26A through 34B enables to enhance the light use efficiency of illumination light in the optical system 20, and increase the luminance of a projection image.

### C. Another arrangement example of Light source unit

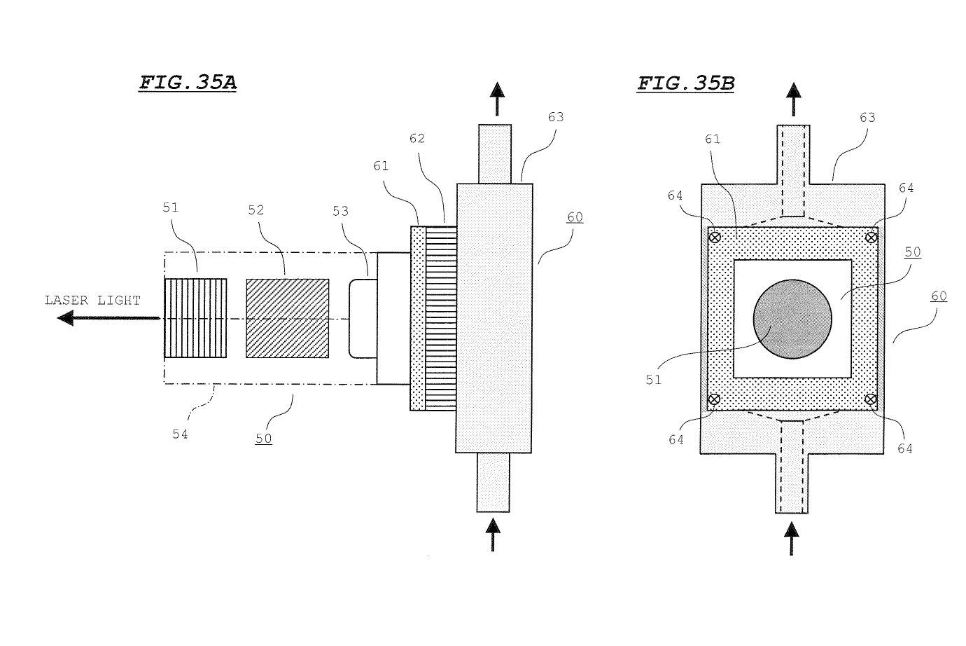

FIGS. 35A and 35B are diagrams showing another arrangement example of a light source unit. FIG. 35A is a side view of the light source unit, and FIG. 35B is a front view of the light source unit.

Referring to FIGS. 35A and 35B, a light source unit is constituted of the laser light source 50 and the cooling portion 60. As well as the laser light source in the first embodiment, the laser light source 50 is constituted of a reflection element having a first wavelength selectivity, a wavelength conversion element 52, a laser diode 53, and a housing 54 for housing the reflection element 51, the wavelength conversion element 52, and the laser diode 53.

The cooling portion 60 is constituted of a copper plate 61, a Peltier element 62, and a liquid cooling jacket 63. The copper plate 61 is mounted on a back surface of the laser diode 53 to diffuse the heat generated in the laser diode 53. The Peltier element 62 is mounted on the copperplate 61 to transfer the heat diffused by the copper plate 61 to the liquid cooling jacket 63. The copper plate 61 and the Peltier element 62 are mounted on a front surface (attachment surface) of the liquid cooling jacket 63 by four screws 64. In this arrangement, a graphite sheet or an indium sheet having a high thermal conductivity is disposed in a boundary surface between the laser diode 53 and the copper plate 61, a boundary surface between the copper plate 61 and the Peltier element 62, and a boundary surface between the Peltier element 62 and the liquid cooling jacket 63. Alternatively, a thermal grease may be coated on each of the boundary surfaces, in place of using these sheets.

The Peltier element 62 in the cooling portion 60 may be omitted. In the modification, the copper plate 61 is directly attached to the liquid cooling jacket 63.

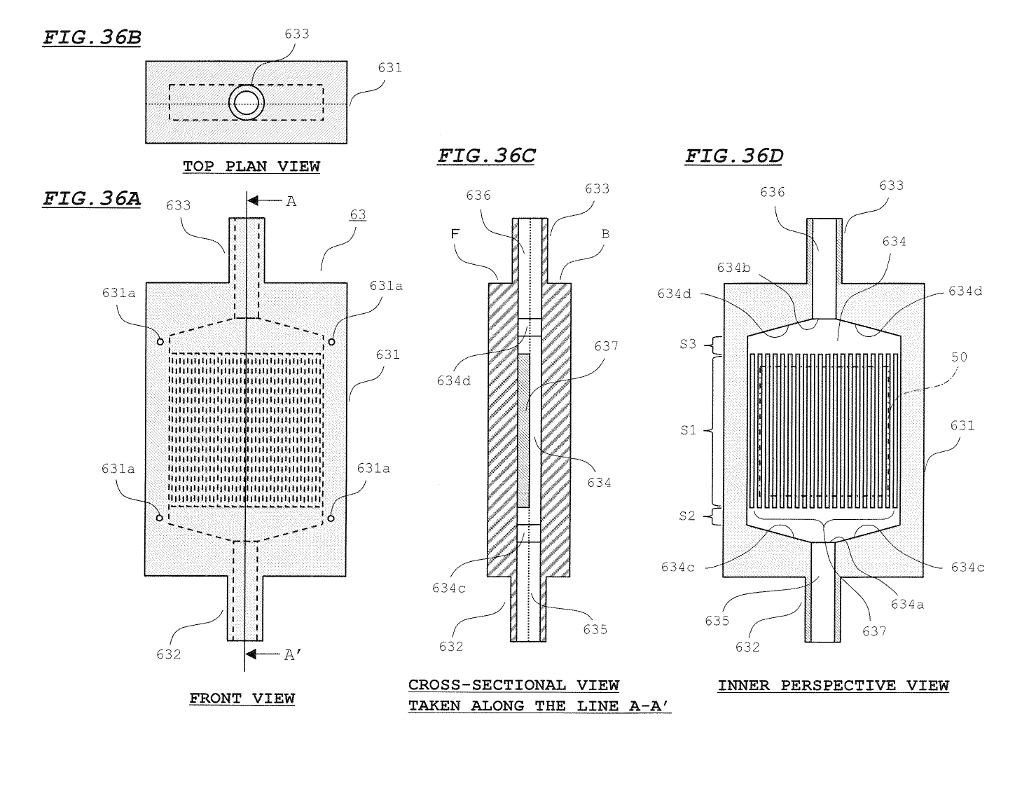

FIGS. 36A, 36B, 36C, and 36D are diagrams showing an arrangement of the liquid cooling jacket 63. FIGS. 36A and 36B are respectively a front view and a top plan view of the liquid cooling jacket 63. FIG. 36C is a cross-sectional view taken along the line A-A′ in FIG. 36A, and FIG. 36D is an inner perspective view of the liquid cooling jacket 63, when viewed from a front side of the liquid cooling jacket 63.

The liquid cooling jacket 63 is constituted of a jacket portion 631, an inlet portion 632 projecting from a lower surface of the jacket portion 631, and an outlet portion 633 projecting from an upper surface of the jacket portion 631.

The liquid cooling jacket 63 is made of a material having a high thermal conductivity such as aluminum or copper. As shown in FIG. 36C, the liquid cooling jacket 63 is formed by joining a front jacket portion F and a back jacket portion B at a central part by welding or a like process.

Four screw holes 631a for fixing the copper plate 61 and the Peltier element 62 with respect to the jacket portion 631 by the screws 64 are formed in a front surface of the jacket portion 631. Further, a flow channel 634 is formed in the interior of the jacket portion 631. An entrance 634a is formed in a lower surface of the flow channel 634, and an exit 634b is formed in an upper surface of the flow channel 634. The entrance 634a is communicated with an inlet path 635 formed in the inlet portion 632, and the exit 634b is communicated with an outlet path 636 formed in the outlet portion 633.

As shown in FIG. 36D, plural straight fins 637 are disposed in the flow channel 634 with a predetermined interval (e.g. 1 mm) in left and right directions. Each of the straight fins 637 projects from a front surface of the flow channel 634 in rearward direction, and extends in up and down directions along a flow of a refrigerant in the flow channel 634. The straight fins 637 are formed in such a manner that the laser light source 50 is disposed in an area where the straight fins 637 are disposed, when viewed from the front side of the liquid cooling jacket 63.

A slope 634c is formed on a lower portion of the flow channel 634 in such a manner that the flow channel 634 is gradually expanded from the entrance 634a. A slope 634d is formed on an upper portion of the flow channel 634 in such a manner that the flow channel 634 is gradually narrowed toward the exit 634b.

Further, an area S2 having the same transverse width as a disposition area S1 where the straight fins are disposed is formed between lower ends of the straight fins 637 and the slope 634c; and an area S3 having the same transverse width as the disposition area S1 is formed between upper ends of the straight fins 637 and the slope 634d.

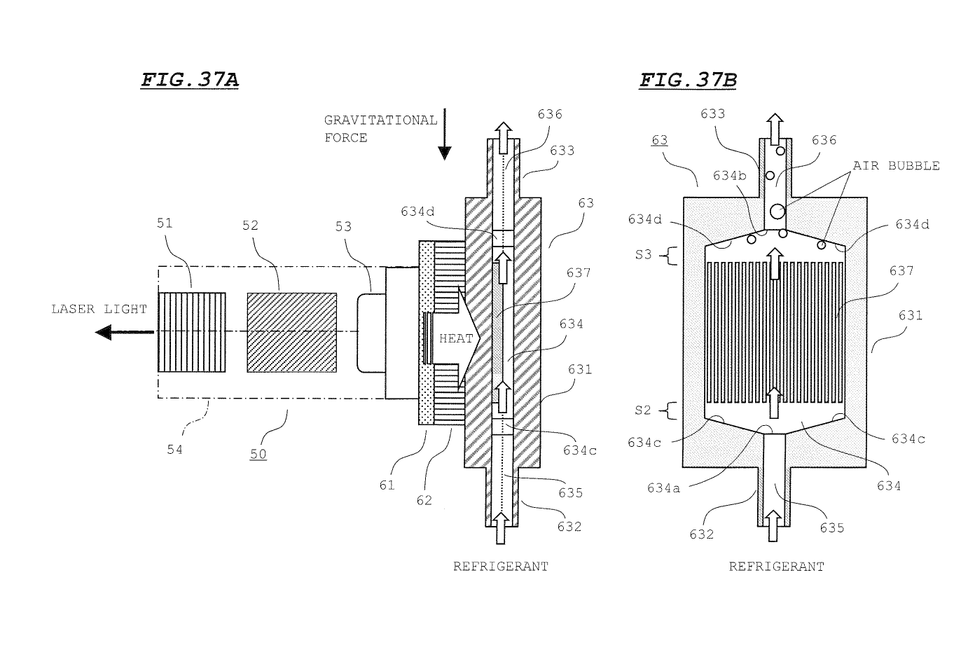

FIGS. 37A and 37B are diagrams for describing a cooling operation of the laser light source 50 to be performed by the cooling portion 60. FIG. 37A is a side view, with a portion corresponding to the liquid cooling jacket 63 being illustrated as a cross-sectional view. FIG. 37B is an inner perspective view, when viewed from the front side of the liquid cooling jacket 63.

Referring to FIGS. 37A and 37B, the cooling portion 60 is disposed in a state that a surface (front surface of the liquid cooling jacket 63) where the laser light source 50 is mounted is aligned with up and down directions of the projector, in other words, a gravitational force direction. In this arrangement, the entrance 634a of the flow channel 634 is positioned on the lower side in the gravitational force direction, and the exit 634b of the flow channel 634 is positioned on the upper side in the gravitational force direction.

The plumbing pipes (not shown) from the radiator 31 of the cooling device 30 shown in FIGS. 1A and 1B are connected to the inlet portion 632 and the outlet portion 633 of the liquid cooling jacket 63. In this arrangement, a refrigerant flows in through the inlet portion 632, and flows out through the outlet portion 633 via the flow channel 634. In this way, the refrigerant is circulated through the flow channel 634 in the liquid cooling jacket 63 and the radiator 31. Water or an ethylene-glycol-based liquid medium may be used as the refrigerant.

A heat generated in the laser light source 50 is transferred to the liquid cooling jacket 63 through the copper plate 61 and the Peltier element 62. Then, the heat transferred to the liquid cooling jacket 63 is heat-exchanged with the refrigerant flowing through the flow channel 634 at the front surface of the flow channel 634 and the straight fins 637 to be transferred to the refrigerant. The heat is then transferred to the radiator 31 by the refrigerant, and removed by the air passing the radiator 31.

There is a case that air bubbles are generated in the flow channel 634 of the liquid cooling jacket 63, resulting from e.g. intrusion of air into the refrigerant, or evaporation of air dissolved in the refrigerant from the refrigerant. In this case, if the air bubbles stagnate in the liquid cooling jacket 63, the heat transferred from the laser light source 50 may not be sufficiently transferred to the refrigerant by the air bubbles (due to an increase of thermal resistance), with the result that a cooling effect of the laser light source 50 may not be sufficiently obtained. In such a case, the laser light source 50 may be deteriorated (lifetime of the laser light source 50 may be reduced).

In contrast, in this arrangement example, the front surface of the liquid cooling jacket 63 where the laser light source 50 is mounted is aligned with the gravitational force direction, and the exit 634b is formed in the upper portion of the flow channel 634. Accordingly, as shown in FIG. 37B, the air bubbles generated in the flow channel 634 are moved to the upper portion of the flow channel 634, and discharged through the exit 634b and the outlet path 636 along with the refrigerant.

Accordingly, in this arrangement example, air bubbles are less likely to stagnate on the front surface of the flow channel 634, or the portion corresponding to the straight fins 637, where a heat exchange between the heat from the laser light source 50, and the refrigerant is mainly performed. As a result, since an increase of thermal resistance due to air bubbles is suppressed, a cooling effect of the laser light source 50 can be maintained.

Since the width of the lower portion of the flow channel 634 is gradually increased by the slope 634c, and the width of the upper portion of the flow channel 634 is gradually decreased by the slope 634d, a resistance in the flow channel is reduced, and the refrigerant is allowed to flow smoothly in the flow channel 634. Further, the air bubbles are smoothly guided and discharged to the exit 634b in the upper portion of the flow channel 634 by the slope 634d.

Further, the areas S2 and S3 are formed at positions anterior and posterior to the straight fins 637 to prevent the width of the flow channel 634 from reducing immediately from an end portion of the straight fins 637. This arrangement further reduces a resistance in the flow channel, thereby smoothly flowing the refrigerant. Furthermore, a sufficient clearance (area S3) is secured between the upper ends of the straight fins 637, and the upper surface of the flow channel 634 at both of left and right corner ends on the upper portion of the flow channel. Accordingly, as compared with an arrangement, in which the clearance (area S3) is not formed, air bubbles passing the left and right corner ends can be easily released from the straight fins 637. Thus, discharge of air bubbles is smoothly performed.

As described above, forming the entrance 634a and the exit 634b at upper and lower positions (in the gravitational force direction) of the flow channel 634, and forming the upper surface and the lower surface of the flow channel 634 into the slopes 634c and 634d not only enables to secure a smooth flow of a refrigerant, but also enables to realize smooth discharge of air bubbles generated in the flow channel 634. In the case where an ethylene-glycol-based liquid medium is used as a refrigerant, the viscosity of the liquid medium is increased, as compared with water. In view of the above, the above arrangement is more desirable to secure a smooth flow.

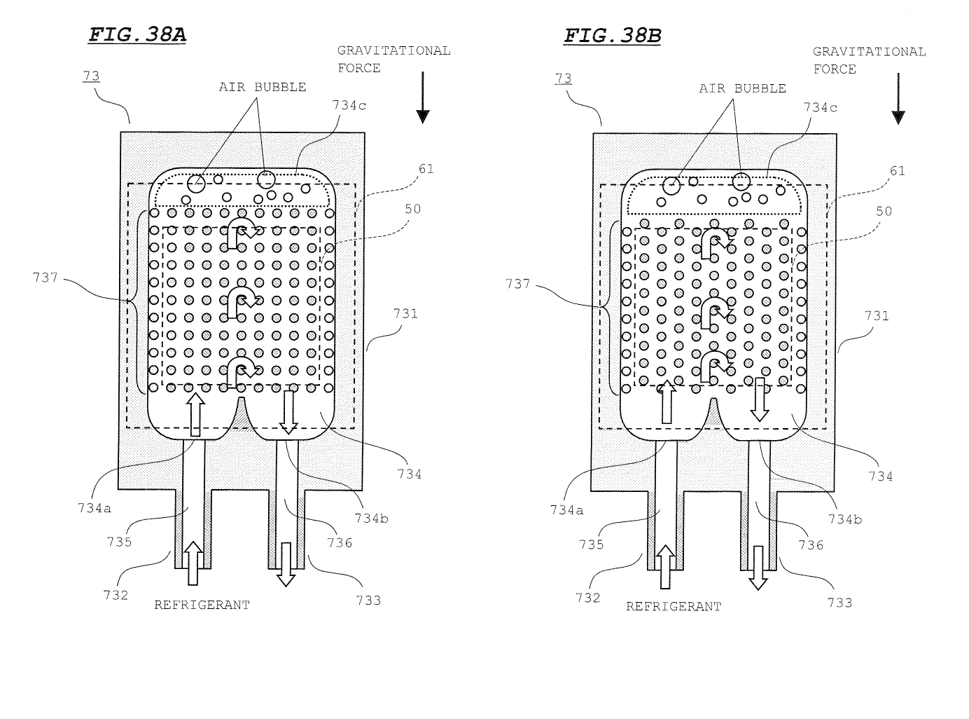

FIGS. 38A and 38B are diagrams showing modification examples of the liquid cooling jacket, specifically, inner perspective views, when viewed from a front side of the liquid cooling jacket. In the modification examples, needle fins 737 are used, in place of the straight fins 637 shown in FIGS. 36A and 36B. The modification example shown in FIG. 38A is different from the modification example shown in FIG. 38B in the arrangement of the needle fins 737.

Referring to FIG. 38A, The liquid cooling jacket 73 is constituted of a jacket portion 731, an inlet portion 732 and an outlet portion 733 projecting from an upper surface of the jacket portion 731.

As well as the liquid cooling jacket 63 described above, the liquid cooling jacket 73 is made of a material having a high thermal conductivity such as aluminum or copper. The liquid cooling jacket 73 is formed by joining a front jacket portion and a back jacket portion at a central part by welding or a like process.

A flow channel 734 is formed in the interior of the jacket portion 731. A lower portion of the flow channel 734 is branched out into two sub-channels. One of the two sub-channels is communicated with an entrance 734a, and the other thereof is communicated with an exit 734b. An inlet path 735 formed in an inlet portion 732 is communicated with the entrance 734a, and an outlet path 736 formed in an outlet portion 733 is communicated with the exit 734b.

The plural needle fins 737 are disposed in a matrix in the flow channel 734 with a predetermined interval (e.g. 1 mm) in up and down directions and left and right directions. The needle fins 737 project from a front surface of the flow channel 734 in rearward direction. The needle fins 737 are formed in such a manner that the laser light source 50 is disposed in an area where the needle fins 737 are disposed, when viewed from the front side of the liquid cooling jacket 73.

A space of a predetermined size devoid of the needle fins 737 is formed between the uppermost array of the needle fins 737 and an upper surface of the flow channel 734. The space serves as an air bubble stagnating portion 734c for stagnating air bubbles generated in the flow channel 734. Inner surfaces of corner portions of the flow channel 734 are formed into curved surfaces to easily flow the refrigerant, as shown in FIGS. 38A and 38B.

The liquid cooling jacket 73 is disposed in a state that a front surface where the laser light source 50 is mounted is aligned with up and down directions of the projector, in other words, a gravitational force direction. The plumbing pipes (not shown) from the radiator 31 of the cooling device 30 shown in FIGS. 1A and 1B are connected to the inlet portion 732 and the outlet portion 733 of the liquid cooling jacket 73. In this arrangement, a refrigerant flows in through the inlet portion 732, and flows out through the outlet portion 733 via the flow channel 734. As shown by the blank arrows in FIGS. 38A and 38B, the flow of the refrigerant in the flow channel 734 is changed from upward direction to downward direction so that the refrigerant substantially passes through a clearance between the respective two needle fins 737 arranged side by side in up and down directions. In this way, the refrigerant is circulated through the flow channel 734 in the liquid cooling jacket 73 and the radiator 31. As well as the cooling jacket 63, water or an ethylene-glycol-based liquid medium may be used as the refrigerant.

The heat transferred to the liquid cooling jacket 73 from the laser light source 50 is heat-exchanged with the refrigerant flowing through the flow channel 734 at the front surface of the flow channel 734 and the needle fins 737 to be transferred to the refrigerant. The heat is then transferred to the radiator 31 by the refrigerant, and removed by the air passing the radiator 31.

In the above arrangement, the liquid cooling jacket 73 is disposed in a state that the front surface thereof where the laser light source 50 is mounted is aligned with the gravitational force direction, and the air bubble stagnating portion 734c is formed in the upper portion of the flow channel 734. Accordingly, air bubbles generated in a flow channel 734 are moved to the air bubble stagnating portion 734c formed in the upper portion of the flow channel 734, and stagnate in the air bubble stagnating portion 734c.

Accordingly, in this arrangement example, air bubbles are less likely to stagnate on the front surface of the flow channel 734, or the portion corresponding to the needle fins 737, where a heat exchange between the heat from the laser light source 50, and the refrigerant is mainly performed. As a result, since an increase of thermal resistance due to air bubbles is suppressed, a cooling effect of the laser light source 50 can be maintained.

The arrangement of the needle fins 737 may be modified as shown in FIG. 38B. In the arrangement example shown in FIG. 38B, the needle fins 737 are formed in such a manner that arrays of the needle fins 737 adjacent to each other in left and right directions are displaced from each other in up and down directions by one-half pitch.

Further, in the arrangements shown in FIGS. 38A and 38B, the inlet portion 732 and the outlet portion 733 of a refrigerant are formed in the lower portion of the liquid cooling jacket 73. Alternatively, as shown in the arrangement in FIGS. 36A and 36B, the inlet portion and the outlet portion of a refrigerant may be respectively formed in the lower portion and the upper portion of the liquid cooling jacket. Further alternatively, the straight fins 637 may be replaced by needle fins in the liquid cooling jacket having the arrangement shown in FIGS. 36A and 36B.

FIGS. 35A through 38B show examples, wherein one laser light source 50 is mounted on one liquid cooling jacket. Alternatively, plural laser light sources 50 may be mounted on one liquid cooling jacket. In the modification, a fin structure may be formed individually on a surface in contact with a corresponding one of the laser light sources, or may be formed in such a manner that all the laser light sources are uniformly covered.

Further, in the arrangements shown in FIGS. 35A through 38B, the cooling portion 60 is disposed in a state that the surface (front surfaces of the liquid cooling jackets 63 and 73) where the laser light source 50 is mounted is aligned with up and down directions of the projector i.e. the gravitational force direction. Alternatively, the laser light source mounting surface may not be strictly aligned in parallel to the gravitational force direction, and may be slightly tilted with respect to the gravitational force direction. Even in a state that the mounting surface is slightly tilted with respect to the gravitational force direction, the air (air bubbles) in the flow channel is retracted in the upper portion of the flow channel by a buoyant force, and is less likely to stagnate near the mounting surface of the laser light source 50. Accordingly, substantially the same effect as described above can be obtained. The expression “the cooling portion is disposed, with a surface thereof where the light source is mounted being aligned with a gravitational force direction” in the claims embraces the above case, wherein the mounting surface of the laser light source 50 is slightly tilted with respect to the gravitational force direction.

The embodiments of the invention have been described as above, but the invention is not limited to the foregoing embodiments. Further, the embodiments of the invention may be changed or modified in various ways.

For instance, in FIGS. 1A and 1B, and FIGS. 24A and 24B, illumination light is entered into the optical system 20 in one direction, and in the above combination examples, light of a red wavelength band, a green wavelength band, and a blue wavelength band is combined by a prism mirror for incidence into the optical system 20. Alternatively, it is possible to apply the invention to an optical system, wherein light of the respective colors is individually entered in three directions into the optical system 20. As described above, in the case where illumination light is entered into the optical system 20 in one direction, the illumination light is temporarily separated into light of a red wavelength band, a green wavelength band, and a blue wavelength band in the optical system 20, followed by modulation of the light of the respective colors by imagers, and then, the separated light is combined by a dichroic cube for incidence into the projection lens 21. Further, in the case where light of the respective colors is entered in three directions, the light of the respective colors is guided to imagers (liquid crystal panels) by corresponding light guiding optical systems for modulation, and then, the modulated light is combined by a dichroic cube for incidence into the projection lens 21. In the case where light of the respective colors is entered in three directions, the illumination device in each of the above combination examples is individually disposed with respect to the light guiding optical systems of the respective colors. In this case, all the light source units in each of the above combination examples are modified to emit laser light of a same wavelength band. For instance, in the illumination device of the combination example, wherein illumination light is supplied to a light guiding optical system for green light, all the light source units emit laser light of a green wavelength band, and the emitted laser light is combined into illumination light by a prism mirror.

In the forgoing embodiments, laser light is combined by using a prism mirror. Alternatively, it is possible to use two mirrors or an edge mirror, in place of the prism mirror. The embodiments of the invention may be changed or modified in various ways as necessary, as far as such changes and modifications do not depart from the scope of the claims of the invention hereinafter defined.

What is claimed is:

1. A projection display device comprising:
an optical system which modulates light based on an image signal to generate and output image light;
an illumination device which includes a plurality of light sources, and emits illumination light in a predetermined axis direction in parallel to an installation plane of the optical system to supply the illumination light to the optical system;
a heat transfer system which transfers a heat generated in the light sources in a direction generally perpendicular to the installation plane; and
a cooling device which is disposed in a direction generally perpendicular to the installation plane, and removes the heat transferred by the heat transfer system.

2. The projection display device according to claim 1, wherein
at least two of the plurality of the light sources emit light in a same direction, and
the two light sources are disposed at forward and rearward positions in the light emission direction, the rearward light source being disposed at a position displaced with respect to the forward light source in a direction opposite to the heat transfer direction by a predetermined distance.

3. The projection display device according to claim 2, wherein
a cooling portion constituting apart of the heat transfer system is mounted on each of the two light sources, and
the two light sources are disposed at such positions that a whole silhouette of one of the two light sources and the corresponding cooling portion in the light emission direction and a whole silhouette of another of the two light sources and the corresponding cooling portion in the light emission direction are partially overlapped with each other in a direction in parallel to the heat transfer direction.

4. The projection display device according to claim 1, wherein
at least two of the plurality of the light sources emit light in a same direction, and
the two light sources are disposed side by side in a direction perpendicular to the installation plane, with a cooling portion constituting a part of the heat transfer system being mounted in common between the two light sources.

5. The projection display device according to claim 1, wherein
at least two of the plurality of the light sources emit light in a same direction,
the two light sources are disposed in the light emission direction by a predetermined distance, and in a direction in parallel to the installation plane and perpendicular to the light emission direction by a predetermined distance,
a cooling portion constituting a part of the heat transfer system is mounted on each of the two light sources, and
the two light sources are disposed at such positions that a whole silhouette of one of the two light sources and the corresponding cooling portion in the light emission direction and a whole silhouette of another of the two light sources and the corresponding cooling portion in the light emission direction are partially overlapped with each other in a direction in parallel to the installation plane and perpendicular to the light emission direction.

6. The projection display device according to claim 1, wherein
at least two of the plurality of the light sources emit light in a same direction, and
the two light sources are disposed side by side in a direction perpendicular to the light emission direction and in parallel to the installation plane, with a cooling portion constituting a part of the heat transfer system being mounted in common between the two light sources.

7. The projection display device according to claim 1, wherein
the heat transfer system includes a cooling portion which is mounted with the light sources and which is internally formed with a flow channel through which a refrigerant from the cooling device is circulated, and
the cooling portion is disposed, with a surface thereof where the light sources are mounted being aligned with a gravitational force direction.

8. The projection display device according to claim 7, wherein
the cooling portion is formed with the flow channel of such a shape as to flow the refrigerant upward, and
an inlet portion and an outlet portion of the refrigerant are formed in a lower portion and an upper portion of the cooling portion in such a manner as to communicate with the flow channel.

9. An illumination device provided with a plurality of light sources, and adapted to emit light from the plurality of the light sources in a first axis direction, the illumination device comprising:
a heat transfer system which transfers a heat generated in the light sources in a second axis direction perpendicular to the first axis direction; and
a cooling device which is provided in a direction perpendicular to the first axis direction, and removes the heat transferred by the heat transfer system.

10. An illumination device provided with a plurality of light sources, and adapted to emit light from the plurality of the light sources in a first axis direction, the illumination device comprising:
a first light source which emits light in a second axis direction perpendicular to the first axis direction;
a first heat transfer system which transfers a heat generated in the first light source in a third axis direction perpendicular to the first axis direction and the second axis direction;
a second light source which emits light in the second axis direction, and is disposed at a forward position or a rearward position in a light emission direction of the first light source;
a second heat transfer system which transfers a heat generated in the second light source in the third axis direction;
a cooling device which is disposed in the third axis direction, and removes the heats transferred by the first heat transfer system and the second transfer system; and
reflection means which guides the light emitted from the first light source and the light emitted from the second light source in the first axis direction, wherein
the first light source and the second light source are disposed at such positions that the rearward light source is displaced with respect to the forward light source in a direction opposite to the heat transfer direction.

11. A projection display device comprising:
an optical system which modulates light based on an image signal to generate and output image light;
a light source which supplies the light to the optical system;
a heat transfer system which transfers a heat generated in the light source; and
a cooling device which removes the heat transferred by the heat transfer system, wherein
the heat transfer system includes a cooling portion which is mounted with the light source, and which is internally formed with a flow channel through which a refrigerant from the cooling device is circulated, and
the cooling portion is disposed, with a surface thereof where the light source is mounted being aligned with a gravitational force direction.
